(19) United States
(12) Patent Application Publication
(10) Pub. No.: US 2026/0179021 A1
(43) Pub. Date: Jun. 25, 2026

(54) Method for diagnosing structural in-service performance based on high dam risk mode and failure path

(71) Applicant: Nanjing Hydraulic Research Institute, Nanjing (CN)

(72) Inventors: Yan XIANG, Nanjing (CN); Yakun WANG, Nanjing (CN); Ying MENG, Nanjing (CN); Kai ZHANG, Nanjing (CN); Bo DAI, Nanjing (CN); Guangze SHEN, Nanjing (CN); Chengdong LIU, Nanjing (CN); Xin YANG, Nanjing (CN); Jingxuan ZHANG, Nanjing (CN)

(73) Assignee: Nanjing Hydraulic Research Institute, Nanjing (CN)

(21) Appl. No.: 19/539,473

(22) Filed: Feb. 13, 2026

(30) Foreign Application Priority Data
Apr. 14, 2025 (CN) 202510458740
Apr. 14, 2025 (CN) CN 202510458740.8

(51) Int. Cl. G06Q 10/0635; G06N 7/01

(52) U.S. Cl. CPC G06Q 10/0635; G06N 7/01

(57) ABSTRACT

The present disclosure provides a method for diagnosing structural in-service performance based on high dam risk mode and failure path. The method includes: constructing a high dam risk incident case database and extracting risk feature parameters; applying multi-scale hierarchical adaptive correspondence analysis, and resolving the problem of imbalance feature weights through feature weight calculation, hierarchical weighting of risk modes, establishment of physical similarity indices, and structural difference compensation, generating a weighted similar-project ranking list; constructing a time-series adaptive network model with multiple failure modes coupled to address the imperfect time-series evolution mechanism of failure paths, and outputting a time-series failure path prediction model; combining the similar-project ranking list and the time-series failure path prediction model to conduct engineering analogy analysis and generate a high dam safety status assessment report.

### CROSS-REFERENCE TO RELATED APPLICATION

The present disclosure claims priority to Chinese Patent Application No. 202510458740.8, filed on Apr. 14, 2025 before the China National Intellectual Property Administration, the disclosure of which is incorporated herein by reference in entirety.

### TECHNICAL FIELD

The present disclosure relates to the field of building diagnostic technology, and in particular to a method for diagnosing structural in-service performance based on high dam risk mode and failure path.

### BACKGROUND

High dams and large reservoirs, as major water conservancy infrastructure, play a vital role in ensuring flood control, water supply, irrigation, and safety. With the increase of service time and the impact of extreme events such as earthquakes and floods exceeding design limits, the probability of high dams developing defects such as cracks and severe leakage increases, leading to losses. Therefore, systematically analyzing the high dam risk modes and failure paths and establishing scientific methods for diagnosing their structural in-service performance is of significant theoretical and engineering value for ensuring the safe operation of water conservancy projects, and it is a hot research topic both domestically and internationally.

Currently, domestic and international high dam safety assessments primarily rely on in-situ monitoring and field testing to obtain information on dam defects. Physical formation mechanisms of these defects are revealed through the establishment of monitoring models, simulation experiments, and structural numerical calculations. For example, neural network-based high dam safety assessment methods utilize historical monitoring data for mode recognition and early warning; risk probability analysis-based assessment methods calculate failure probabilities using Monte Carlo simulations; and finite element analysis-based assessment methods analyze the stress, deformation, and seepage characteristics of high dams under different operating conditions through numerical simulations. Furthermore, multivariate correspondence analysis is applied to engineering analogy analysis, providing a reference basis for safety assessments by comparing the similarity between the high dam to be assessed and historical cases.

However, existing technologies still face key technical challenges in diagnosing high dam risk modes and failure paths. On one hand, traditional multivariate correspondence analysis generally employs equal weighting, neglecting the varying degrees of influence of different feature parameters on risk modes and failure paths. This leads to an overemphasis on secondary features and neglect of key factors during engineering analogies, reducing diagnostic accuracy. On the other hand, existing failure path analyses primarily present static topological structures, lacking a precise characterization of the temporal evolution relationships among various stages of the failure process. This fails to reflect the rate of defect development and the temporal dimension of the failure process, resulting in a lack of temporal precision in high dam operational risk warnings and life assessments. These problems are particularly prominent in 300 m-class ultra-high dam projects, because of the short operational time and insufficient accumulation of monitoring information, it exceeds existing technical levels and regulatory requirements, necessitating the development of novel diagnostic methods.

### SUMMARY

The objective of the present disclosure is to provide a method for diagnosing structural in-service performance based on high dam risk mode and failure path, in order to solve at least one technical problem existing in the prior art.

Technical solutions of the present disclosure includes: A method for diagnosing structural in-service performance based on high dam risk mode and failure path, comprising the following steps:
collecting information on high dam risk incident cases, constructing a high dam risk incident case database, and extracting feature parameters, risk modes, and failure paths to form a high dam risk incident case dataset;
based on the high dam risk incident case dataset, applying multi-scale hierarchical adaptive correspondence analysis to generate a weighted similar-project ranking list;
based on the high dam risk incident case dataset, constructing a time-series adaptive network model with multiple failure modes coupled to output a time-series failure path prediction model;
by combining the weighted similar-project ranking list and the time-series failure path prediction model, performing an engineering analogy analysis on a high dam to be evaluated, to generate a service safety diagnosis report.

Beneficial effects: The present disclosure provides a new technical approach and solution for high dam safety assessment and risk management. The relevant technical effects will be described in detail with case studies.

### BRIEF DESCRIPTION OF THE DRAWINGS

FIG. 1 is a flowchart of the present disclosure.

FIG. 2 is a flowchart of the process for generating a weighted similar project ranking list according to the present disclosure.

FIG. 3 is a flowchart of the calculation of the feature weight vector in present disclosure.

FIG. 4 is a flowchart of the construction of the mode feature weight matrix in present disclosure.

FIG. 5 is a flowchart of the calculation process of the modified physical similarity index matrix of the present disclosure.

### DETAILED DESCRIPTION OF EMBODIMENTS

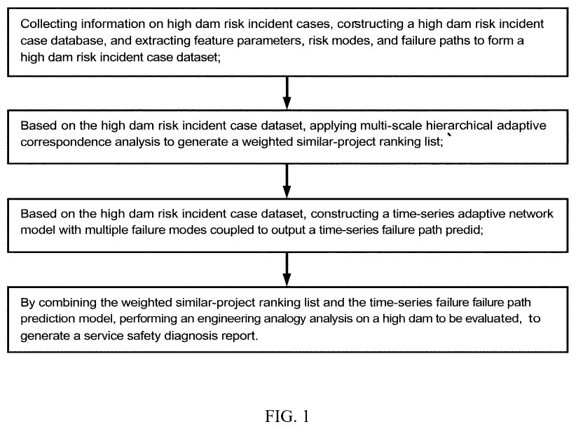

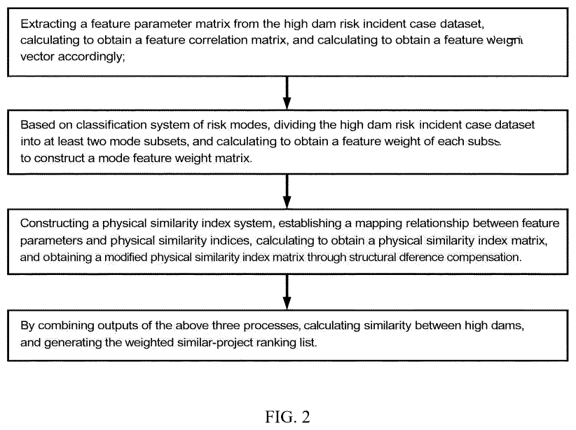

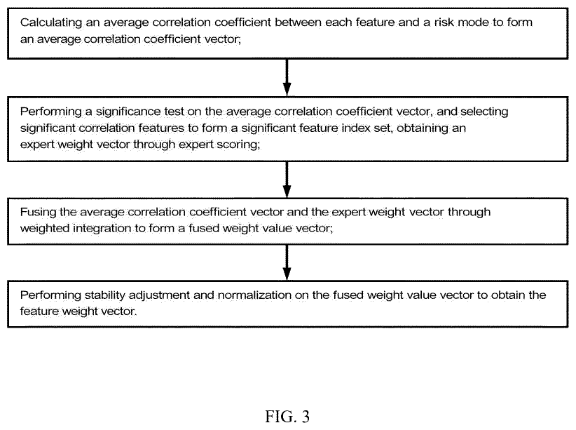

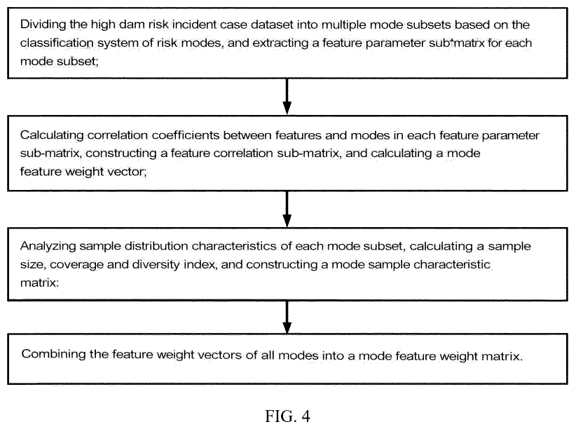

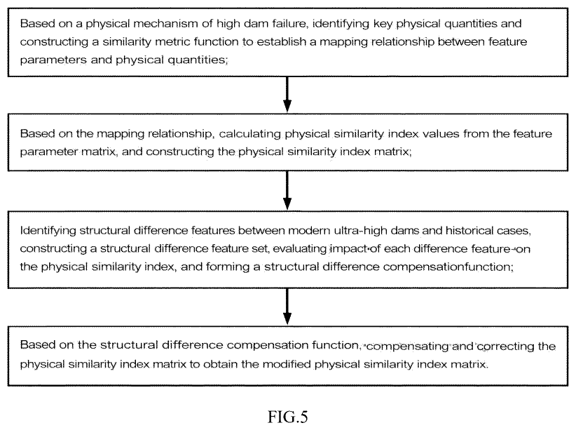

As shown in FIGS. 1 to 5, the technical solution of the present disclosure includes the following steps:

S1. Collect information on high dam risk incident cases from both domestic and international sources, construct a structured database, extract risk feature parameters, and form a high dam risk incident case dataset.

S11. Obtain original case information from engineering literature, incident reports, and monitoring records, including basic parameters of high dams (dam type, dam height, reservoir capacity, construction year, and country) and incident information (time of incident, type of incident, location of incident, and handling measures).

S12. Perform data cleaning and standardization on the original case information, remove outliers and cases with severe missing values, unify the units of measurement and classification standards, and generate standardized case data.

S13. Based on standardized case data, extract dam structural features (such as dam type coefficient, dam height ratio, and thickness coefficient), hydrogeological features (such as reservoir capacity coefficient and geological conditions), and operating environment features (such as meteorological conditions and operating years) to form a feature parameter matrix X.

S14. Conduct risk mode analysis on standardized case data, identify three main risk modes (crack, abnormal deformation, and seepage) and their subtypes, and construct a risk/incident mode classification system Y.

S15. Analyze the risk evolution process in standardized case data, identify the logical relationship between the cause of the incident, the development process, and the failure result, and construct the initial failure path network Z.

S16. Integrate the feature parameter matrix X, the risk mode classification system Y, and the initial failure path network Z into a structured database to form a complete dataset of high dam incident cases (a high dam risk incident case dataset).

S2. Based on the high dam risk incident case dataset, multi-scale hierarchical adaptive correspondence analysis is applied to solve the problem of unbalanced feature weights and generate a weighted similar-project ranking list.

S21. Extract the feature parameter matrix X from the high dam risk incident case dataset, calculate the point bicolumn correlation coefficient ρᵢⱼ between each feature parameter and the risk mode, and construct the feature correlation matrix R.

S22. Based on the feature correlation matrix R, calculate the average correlation coefficient ρj for each feature and normalize it to obtain the initial feature weight vector W0. This solves the limitations of equal weight processing and highlights the importance of key features.

S23. Based on the risk mode classification system Y, the high dam risk incident case dataset is divided into m subsets C1, C2, . . . , Cm. Feature weights are calculated separately for each subset to obtain the mode feature weight matrix WM. This solves the problem of varying feature importance under different risk modes.

S24. Construct a risk mode correlation matrix R, where matrix elements rᵢⱼ represent the correlation between risk modes i and j, calculated based on co-occurrence frequency and conversion probability. This step considers the evolutionary relationship between risk modes.

S25: Construct a physical similarity index system, including n physical indices such as stress distribution similarity (o similarity), deformation mode similarity (¿ similarity), and seepage field similarity (Φ similarity). Establish a mapping relationship F between the physical indices and basic feature parameters: feature parameter matrix X→physical similarity index matrix P. Introducing physical mechanisms enhances the scientific rigor of the similarity analysis.

S26. Apply the mapping relation F to the feature parameter matrix X to obtain the physical similarity index matrix P for all historical cases. For the special structural characteristics of modern ultra-high dams, design a structural difference compensation function H to correct the physical similarity index, obtaining the corrected/modified physical similarity index matrix P′. This solves the problem of structural representativeness differences between new high dams and historical cases.

S27. Extract the feature parameters of the high dam to be evaluated, construct the feature vector X0 of the high dam to be evaluated, and obtain the physical similarity index vector P0 of the high dam to be evaluated through the mapping relationship F and the compensation function H.

S28. Calculate the weighted Euclidean distances DX of the feature vector X0 of the high dam to be evaluated and each case in the feature parameter matrix X in the original feature space. Determine the weights based on the feature correlation matrix R, the mode feature weight matrix WM, and the risk mode correlation matrix R. Simultaneously, calculate the weighted Euclidean distances DP of the physical similarity index vector P0 of the high dam to be evaluated and the modified physical similarity index matrix P′ in the physical similarity space.

S29. A multi-scale fusion strategy is adopted to calculate the final similarity S=α·f(DX)+(1−α)·g(DP), in consideration of DX and DP, where a is an adaptive weighting factor, and f and g are distance-similarity transformation functions. Based on the final similarity S, historical cases are ranked to generate a weighted similar-project ranking list. By fully utilizing the advantages of the original feature space and physical similarity space, the reliability of similar project screening is improved.

S3. Using the failure information in the high dam risk incident case dataset, construct a time-series adaptive network model with multiple failure modes coupled to solve the problem of imperfect failure path time-series evolution mechanism, and output a time-series failure path prediction model.

S31. Extract the initial failure path network Z from the high dam risk incident case dataset, define each node in the network as a state Si of a Markov chain, add the normal state S0 and the final failure state Sf to form the complete state space S.

S32. Based on historical cases in the high dam risk incident case dataset, the transition frequency between each state is statistically analyzed, and the state transition probability matrix P is calculated, where Pᵢⱼ represents the transition probability from state Si to state Sj. This overcomes the limitation of only representing the logical order without quantifying the probability.

S33. For each state transition process Si→Sj, extract time records from the high dam risk incident case dataset, fit its time distribution function Tᵢⱼ(t) and its parameters (mean μᵢⱼ, varianceoᵢⱼ²), and construct the state duration distribution matrix D. Introducing the time dimension into failure path analysis solves the problem that static paths cannot reflect temporal characteristics.

S34. Analyze the main external factors (water level, temperature, load, etc.) that affect the failure process of high dams, extract relevant monitoring data from the high dam risk incident case dataset, and construct an external factor data matrix F.

S35. Establish a conditional state transition probability function Pᵢⱼ(F1,F2, . . . ,Fk), which represents the change relationship between the state transition probability and external factors. Simultaneously, establish the mapping relationship between the time distribution parameters and external factors: μᵢⱼ=g(F1,F2, . . . ,Fk), oᵢⱼ²=h(F1,F2, . . . ,Fk). This function can adapt to non-stationary failure processes under complex operating conditions.

S36. Model different types of failure modes (crack, deformation, seepage, etc.) as independent network layers to construct a multi-layer failure mode network M. Define the coupling strength matrix C between failure modes, where Cᵢⱼ represents the influence strength of failure mode i on mode j. This can characterize the interaction between failure modes.

S37. A rule-based path generation engine is adopted to automatically generate new possible paths in the multi-layer failure mode network M according to the failure mode coupling relationship, dynamically update the initial failure path network Z, and form an extended failure path network Z′. This solves the problem that preset paths cannot cover path mutations.

S38. Based on the state transition probability matrix P, state duration distribution matrices D and F, multi-layer failure mode network M, and extended failure path network Z′, a comprehensive temporal (time series) evolution model is constructed to achieve multi-scale (macroscopic state sequence, mesoscopic network propagation, and microscopic physical evolution) simulation of the failure process. Full-scale temporal modeling of the high dam failure process is realized.

S39. Using the Monte Carlo simulation method, a large number of possible failure time paths are generated. The time characteristics of typical failure paths are statistically analyzed to identify key nodes and critical states that may lead to path mutations, thus forming a complete time-series failure path prediction model.

S4. Combining the weighted similar project ranking list and the time-series failure path prediction model, conduct an engineering analogy analysis for the high dam to be evaluated, and generate a high dam safety status assessment report.

S41. Select k projects with the highest similarity from the weighted similar project ranking list as the core analog project set, analyze their risk modes, locations and causes, and predict the possible risk modes of the high dam to be evaluated.

S42. Input the monitoring data of the high dam to be evaluated as the initial state information into the time-series failure path prediction model, simulate and predict its possible failure evolution path and time window, and generate a failure risk time series diagram.

S43. For typical projects with a concentration of core analogous projects, and in combination with the characteristics of the high dam to be evaluated, construct a finite element numerical model, conduct failure mechanism analysis, verify the rationality of potential hazard/risk modes and failure risk time series diagrams, and form verification analysis results.

S44. Based on potential hazard modes, failure risk time series diagrams, and verification analysis results, comprehensively assess the safety status of the high dam to be evaluated, determine the risk level, propose targeted monitoring and intervention strategies, and generate a high dam safety status assessment report.

According to one aspect of the present disclosure, step S15 specifically comprises:

S151. Extract the sequence of incidents for each case from the standardized case data, including the incident phenomenon, the time of occurrence, the development status and the scope of impact, to form incident time series data E.

S152. Perform time-series decomposition on the incident data E, identifying the initial event, intermediate development events, and final result event in each case, and construct a case-level event chain set L. Through time window segmentation and event correlation analysis, achieve precise deconstruction of the incident process.

S153. Semantic normalization is performed on all events in the event chain set L, merging events with different descriptions but the same essence into a unified standardized event type set T. This step uses an ontology mapping method based on expert knowledge, which solves the problem of inconsistent event descriptions in different projects and documents.

S154. Based on the event type set T, analyze the dependencies between events in the event chain set L, count the transition frequency between each event pair, and form an event transition frequency matrix F. The matrix element fᵢⱼ represents the historical number of occurrences from event i to event j.

S155. Normalize the event transition frequency matrix F, calculate the conditional probability P(j|i)=fᵢⱼ/Σfik, and construct the event transition probability matrix Pₑᵥₑₙₜ. Probabilistic statistical methods are introduced to transform qualitative failure paths into quantifiable probabilistic models.

S156. Based on the event transition probability matrix Pₑᵥₑₙₜ, the minimum support tree algorithm is used to extract the main event transition paths, and the transition relationships with probabilities lower than the threshold 0 are removed to obtain the core event transition network N_{core}.

S157. Combining the theory of high dam engineering mechanics and expert knowledge, the physical rationality of the event transfer/transition relationships in the core event transfer/transition network N_{core} is verified. Physically unreasonable transfer edges are deleted, and transfer edges that must exist physically but are missing in the data are added to form a physically corrected event network N_{phy}.

S158. Classify the events in the event type set T into two dimensions according to the type of incident (crack, deformation, seepage, etc.) and the development stage (initiation, development, failure), and construct the event classification matrix C. This matrix provides a structured framework for the multidimensional display of failure paths.

S159. Based on the physically modified event network N_{phy} and the event classification matrix C, a graph-structured initial failure path network Z is constructed, where nodes represent event types, edges represent event transition/transfer relationships, and edge weights represent transition probabilities. This network retains the topological structure of the failure process while incorporating probabilistic characteristics, laying the foundation for subsequent time-series evolution analysis.

According to one aspect of the present disclosure, step S22 specifically comprises:

S221. Read the feature correlation matrix R, extract the correlation coefficient ρᵢⱼ between each feature parameter j and all risk modes, where i represents the risk mode index and j represents the feature parameter index, and construct the feature-incident correlation coefficient set ρ_set.

S222. Perform statistical analysis on the feature-incident correlation coefficient set ρ_set, and calculate the average correlation coefficient ρ_avgⱼ=(1/M)>ρᵢⱼ for each feature j, where M is the total number of risk modes, to obtain the average correlation coefficient vector ρ_avg. Through averaging, the influence of features on different risk modes is comprehensively considered.

S223. Perform a significance test on the values in the average correlation coefficient vector ρ_avg, filter out feature parameters with insignificant correlation (p-value>0.05), retain the significantly correlated feature subset, and construct the significant feature index set J_sig. This step introduces statistical testing methods, improving the scientific rigor of feature weight calculation.

S224. For the features in the significant (salient) feature index set J_sig, an expert scoring mechanism is introduced. Based on historical case analysis experience and theoretical analysis results, the expert weight coefficient eⱼ for each feature is determined, forming an expert weight vector E. Combining expert experience with data statistics enhances the rationality of the weight system.

S225. Design a fusion function f, and fuse by weighted integration the data-driven average correlation coefficient vector ρ_{avg} with the expert weight vector E: fⱼ=α·ρ_{avgj}+(1−α)·eⱼ, where a is an adaptive fusion coefficient that is dynamically adjusted according to data quality. This yields the fusion weight vector F. This achieves the fusion of data-driven and expert knowledge, overcoming the limitations of single weight determination methods.

S226. Perform sensitivity analysis on the fusion weight vector F. By perturbing the weight of each feature and calculating the degree of influence on the result, evaluate the stability influence of each feature and obtain the stability coefficient vector S.

S227. Based on the fused/fusion weight vector F and stability coefficient vector S, a stability enhancement function g is designed, and the stability-adjusted weight values are calculated: gⱼ=Fⱼ·(1+β·Sⱼ), where β is the stability adjustment coefficient. This yields the stability adjusted weight vector G. By considering the stability of the weights, the robustness of the model is enhanced.

S228. Normalize the stability adjusted weight vector G: wⱼ=gⱼ/Σgⱼ, ensuring that the sum of all weights is 1, to obtain the final initial feature weight vector W0. This weight vector overcomes the limitations of weight processing in traditional multivariate correspondence analysis and can more accurately reflect the actual impact of different features on the risk mode.

According to one aspect of the present disclosure, step S23 specifically comprises:

S231. Read the risk mode classification system Y and the high dam risk incident case dataset. Group the cases according to the main risk modes (crack, abnormal deformation, seepage, etc.) to form m mode subsets C1, C2, . . . , Cm. Each subset contains all cases with the same main risk mode.

S232. For each mode subset Ci, extract the list of case IDs and corresponding feature parameters contained therein, and construct a mode-specific feature parameter sub-matrix Xᵢ.

S233. For each feature parameter sub-matrix Xᵢ, calculate the point-to-two-column (point bicolumn) correlation coefficient between each feature and the sub-mode, and construct a mode-specific feature correlation sub-matrix Rᵢ. This achieves stratified correlation analysis of risk modes and can capture the differences in feature importance under specific risk modes.

S234. For each feature correlation sub-matrix Rᵢ, apply the feature weight calculation method from step S22 (S221-S228) to obtain the feature weight vector Wᵢ for a specific risk mode i. This achieves the weight calculation for risk mode specialization.

S235. Analyze the sample distribution characteristics of each risk mode subset Ci, calculate the sample size nᵢ, sample coverage cᵢ, and sample diversity index dᵢ, and construct the mode sample characteristic matrix D. This matrix is used to evaluate the reliability of the weight calculation for each mode subset.

S236. Based on the mode sample characteristic matrix D, a reliability evaluation function h is designed to calculate the reliability coefficient rᵢ=h(nᵢ, cᵢ, dᵢ) of each mode weight vector, and to construct the mode weight reliability vector R_{mode}. A weight reliability evaluation mechanism is introduced to solve the uncertainty problem in the calculation of mode weights for small samples.

S237. For mode j with reliability below the threshold A in the mode weight reliability vector R_{mode}, a transfer learning strategy is adopted to transfer weight information from similar modes for reinforcement: Wⱼ′=Wⱼ+γ·Σ(sim(j,k)·(W_k−Wⱼ)), where sim(j,k) is the similarity between mode j and k, and γ is the transfer strength coefficient. This yields the reinforced weight vector set W′. This solves the problem of weight calculation for rare risk modes and enhances the applicability of the method.

S238. Combine the feature weight vectors (Wᵢ or the reinforced Wⱼ′) of all modes into a two-dimensional mode-feature matrix to form a complete mode feature weight matrix WM. Each row of this matrix represents a risk mode, each column represents a feature parameter, and the matrix element WMᵢⱼ represents the weight value of feature j under risk mode i.

S239. Based on the mode feature weight matrix WM, calculate the coefficient of variation (CV) of each feature weight across different modes, identify mode-sensitive features (large CV values) and mode-stable features (small CV values), and construct a feature mode sensitivity vector S_{feature}. This vector provides important reference information for subsequent weight optimization for specific high dams.

According to one aspect of the present disclosure, step S25 specifically comprises:

S251. Read the feature parameter matrix X and the risk mode classification system Y, analyze the physical mechanism of high dam failure, determine the key physical quantities affecting the safety of high dam, including stress field, deformation field, seepage field and temperature field, and form a set of key physical quantities K.

S252. For each physical quantity in the key physical quantity set K, define its similarity metric, design a similarity calculation function, and form a physical similarity metric function set Φ. This function set includes stress distribution similarity function φ_{σ}, deformation mode similarity function φ_{ε}, seepage field similarity function of, etc. Each function can convert the characteristics of the corresponding physical field into a similarity value between 0 and 1.

S253. Based on high dam mechanics theory and historical case analysis, key feature parameter combinations affecting the distribution of various physical quantities are identified, and a mapping relationship set {M_{σ}, M_{ε}, M_{f}, . . . } between feature parameters and physical quantities is established. For example, the similarity of stress distribution is mainly affected by parameters such as dam type, dam height, and dam thickness ratio; the similarity of seepage field is mainly affected by parameters such as permeability coefficient, seepage prevention facilities, and geological conditions. A mapping mechanism from characteristic space to physical space is established.

S254. Regarding stress distribution similarity (o similarity), a feature subset X_{σ} affecting stress distribution is extracted from the feature parameter matrix X, including dam type coefficient, dam height, thickness-to-height ratio, and bending radius. This subset is then converted into a stress field feature vector using a nonlinear mapping function Mσ, and finally, the stress similarity index Pσ is calculated using the similarity function φσ. This index quantifies the degree of similarity in stress distribution modes among different dam bodies, providing a mechanical perspective for the safety evaluation of high dams.

S255. Regarding deformation mode similarity (ε similarity), a feature subset X_{ε} affecting deformation characteristics is extracted from the feature parameter matrix X, including material elastic modulus, Poisson's ratio, temperature deformation coefficient, etc. This subset is then converted into a deformation field feature vector using the deformation mapping function M_{ε}, and finally, the deformation similarity index P_{ε} is calculated using the similarity function φ_{∈}. This index can compare the similarity of deformation modes among different high dams, and is particularly suitable for assessing anomalous deformation-related hazard modes.

S256. Regarding seepage field similarity (Φ similarity), a feature subset X_{f} affecting seepage characteristics is extracted from the feature parameter matrix X, including permeability coefficient, seepage prevention measures, geological conditions, etc. This subset is then converted into a seepage field feature vector using the seepage mapping function M_{f}, and finally, the seepage similarity index P_{f} is calculated using the similarity function φ_{f}. This index can assess the degree of similarity in seepage characteristics among different high dams and is of great significance for analyzing seepage-related risks.

S257. Combining materials science and damage mechanics theory, a damage evolution similarity index (D similarity) is designed. A feature subset X_d influencing material damage development is extracted from the feature parameter matrix X, including material type, service time, and load history. The damage mapping function M_d is then applied to calculate the damage similarity index P_d. This allows for the assessment of the service state similarity of high dams from a material damage perspective.

S258. For each pair of high dams (i,j), calculate the physical similarity index values to form a physical similarity index vector Pᵢⱼ=[P_{σij}, P_{εij}, P_{fij}, P_dᵢⱼ, . . . ]. Combine the physical similarity index vectors of all high dam pairs into a three-dimensional tensor, and convert it into a two-dimensional matrix through dimensionality compression to construct the complete physical similarity index matrix P. Each row in the matrix corresponds to a high dam case, and each column corresponds to a physical similarity index.

S259. Analyze the correlation between the indicators/indices in the physical similarity index matrix P, identify redundant and complementary indicators, and optimize the physical similarity index system. Finally, determine the mapping relationship F between the physical indicators and the basic feature parameters: feature parameter matrix X→physical similarity index matrix P. This mapping relationship F includes the integration of mapping functions for various physical quantities, which can transform the engineering characteristics of high dams into comparable physical similarity indicators, providing a scientific basis for subsequent screening of similar projects based on physical mechanisms.

According to one aspect of the present disclosure, step S26 specifically comprises:

S261. Read the feature parameter matrix X and the mapping relationship F, apply physical mapping transformation to the feature parameters of each historical case, calculate its physical similarity index value, and construct the original physical similarity index matrix P.

S262. Analyze the differences between modern ultra-high dams and high dams in the historical case library in terms of structural design, material properties, and construction technology, identify key differences, and construct a structural difference feature set D. This set includes the unique features of modern ultra-high dams, such as new dam types, high-performance concrete materials, and special construction techniques, which may lack direct correspondence in historical cases.

S263: For each differential feature dᵢ in the structural difference feature set D, analyze its influence mechanism on each physical similarity index, and construct a difference-influence mapping table M_diff. This table describes the direction and intensity of the influence of each structural difference feature on each physical similarity index. It quantifies the structural representativeness differences between modern ultra-high dams and historical cases.

S264. Based on the difference-influence mapping table M_diff, design a parameterized structural difference compensation function H. This function takes the original physical similarity index P and the structural difference feature dᵢ as input, and outputs the corrected physical similarity index P′: P′=H (P, d_1, d_2, . . . , d_k). The function H adopts a piecewise continuous nonlinear mapping form, which can provide adaptive compensation for different degrees of structural differences.

S265. Using a high-precision finite element model, the influence of typical structural differences is simulated and analyzed to determine the parameter values in the structural difference compensation function H. By comparing the physical field distribution under different structural designs, the physical similarity deviation caused by structural differences is quantified, the compensation function parameters are optimized, and the calibrated structural difference compensation function H_{cal} is obtained.

S266. For novel dam structures in modern ultra-high dams (such as double-curvature arch dams and RCC gravity dams), design a dam structure compensation sub-function H_{dam}, focusing on adjusting the stress distribution and deformation mode similarity indices related to the dam type. By comparing the differences in mechanical behavior between novel and traditional dam types, determine the compensation coefficients and construct the dam type compensation coefficient matrix C_{dam}.

S267. For high-performance materials (such as low-heat cement and high-strength concrete), design a material property compensation sub-function Hₘₐₜ. This function mainly adjusts the damage evolution and temperature field similarity indices related to material properties. Based on materials science theory and experimental data, establish the correspondence between material performance parameters and physical behavior, forming a material compensation coefficient matrix Cₘₐₜ.

S268. Taking into account the improvement of modern construction technology and quality control level, a construction quality compensation sub-function H_{con} is designed. This function adjusts the similarity index of seepage field and interface performance related to construction quality. By comparing the quality differences between modern construction and traditional construction, the compensation coefficient is determined, and a construction compensation coefficient matrix C_{con} is established.

S269. Integrate the various dedicated compensation sub-functions into the main compensation function H_{cal}, and compensate and correct each index value in the physical similarity index matrix P to obtain the corrected physical similarity index matrix P′. This matrix reflects the physical similarity between historical cases and modern ultra-high dams, taking into account structural differences. It overcomes the limitations of relying solely on the comparison of original feature parameters and provides physical mechanism support for accurately selecting similar projects.

According to one aspect of the present disclosure, step S29 specifically comprises:

S291. Read the weighted Euclidean distance DX in the original feature space and the weighted Euclidean distance DP in the physical similarity space, and construct a dual-space distance vector V_{dist}=[DX, DP]. This vector contains the high dam similarity distances measured from two different perspectives.

S292. Design distance-similarity transformation functions f and g to convert distance metrics into similarity metrics: SX=f(DX), SP=g(DP). The transformation functions adopt an exponential decay form: f(d)=exp(−d²/σ²), where σ is a scale parameter, and the optimal value is determined through cross-validation. This achieves the standardization of different spatial distance metrics, enabling them to be effectively compared and integrated.

S293. Analyze the data distribution characteristics of different types of high dams in the high dam risk incident case dataset, evaluate the data quality and representativeness of the original feature space and physical similarity space, and construct a spatial credibility evaluation index set Q=[QX, QP]. The index set includes evaluation indicators of multiple dimensions such as data coverage, sample consistency, and feature completeness.

S294. Based on the spatial credibility assessment index set Q, an adaptive weight factor calculation function h is designed to determine the fusion weight α=h(QX, QP) between the original feature space and the physical similarity space. This function can dynamically adjust the fusion weight according to the data quality of the two spaces, improving the reliability of similarity calculation. It solves the problem of uneven quality between different data spaces.

S295. For different risk modes, design a dedicated spatial weight adjustment coefficient βᵢ, which is adjusted according to the degree of dependence on physical mechanisms based on the risk mode: αᵢ=α·βᵢ. For example, for stress-related crack risk modes, increase the weight of the physical similarity space; for environment-related erosion risk modes, increase the weight of the original feature space. Construct a mode space weight adjustment matrix B to achieve spatial fusion of risk mode specialization.

S296. For the high dam to be evaluated, based on the preliminary risk assessment results, determine the risk probability vector p=[p1, p2, . . . , pm] for each risk mode. The risk probability can be obtained through preliminary monitoring data analysis, expert scoring, or historical case statistics. Combine the risk probability vector p with the mode space weight adjustment matrix B to calculate the comprehensively adjusted adaptive weight factor: α_{adj}=Σ(pi·αᵢ), which comprehensively considers data quality and risk mode characteristics.

S297. Design a multi-scale similarity fusion function, comprehensively considering the original feature space similarity SX and the physical similarity space similarity SP, and calculate the final similarity S=α_{adj}·SX+(1−α_{adj})·SP. For special cases, introduce a nonlinear fusion strategy, using methods such as geometric weighted average or harmonic weighted average to enhance the fusion effect, and construct an enhanced multi-scale fusion similarity Sₑₙₕ.

S298. To address multi-objective optimization needs, a hierarchical similarity calculation method is designed, decomposing the similarity S into multiple sub-similarity indices: S_{struct} similarity), Sₘₐₜ (material similarity), Sₑₙᵥ (environmental similarity), etc., constructing a multi-dimensional similarity vector Sₘᵤₗₜᵢ. This method can characterize the similarity relationships between different high dams in detail from multiple dimensions, supporting more refined screening of similar projects.

S299. Based on the final similarity S or the enhanced multi-scale fusion similarity Sₑₙₕ, historical cases are ranked, and the k projects with the highest similarity are selected as core analogy objects to generate a weighted similar-project ranking list. Simultaneously, based on the multi-dimensional similarity vector Sₘᵤₗₜᵢ, category-specific recommendations for similar projects are provided, generating a multi-dimensional similar project analysis report. This provides a comprehensive and reliable reference for subsequent project analogy analysis. It fully utilizes the advantages of the original feature space and physical similarity space, improving the reliability and adaptability of similar project selection.

According to one aspect of the present disclosure, step S33 specifically comprises:

S331. Select a subset of cases containing complete time records from the high dam risk incident case dataset to form a complete time-series case set T_cases. This set includes cases with clearly recorded start and end times for each failure state, providing a data foundation for time-series analysis.

S332. For each case in the complete time-series case set T_cases, based on the state space S and the state transition probability matrix P, identify the state sequence and state transition process it experiences, extract the transition time data for each pair of adjacent states Si→Sj, and construct a state transition time dataset T data. This dataset records the actual occurrence time of each state transition in historical cases and is the basic data for fitting the time distribution function.

S333. Perform data cleaning and outlier detection on the state transition time dataset T data. Use box plots or Z-scores to identify outlier time records, and replace outliers with reasonable estimates or mark them as missing, resulting in a cleaned time dataset T clean. This improves the data quality for fitting the time distribution.

S334. For each pair of state transition Si→Sj in the cleaned time dataset T clean, extract its transition time samples Tᵢⱼ={t1, t2, . . . , tn}, analyze the data distribution characteristics, use methods such as the Shapiro-Wilk test to test its distribution type, determine a suitable theoretical distribution model, and construct a distribution type mapping table M_{dist}. Optional distribution types include exponential distribution, Weiber distribution, gamma distribution, log-normal distribution, etc., suitable for describing different types of failure processes.

S335. Based on the distribution type determined from the distribution type mapping table M_{dist}, perform parameter estimation for the time samples Tᵢⱼ for each pair of state transitions. Maximum likelihood estimation (MLE) or the method of moments is used to estimate the distribution parameters, obtaining the distribution parameter set {θᵢⱼ}, and constructing the distribution parameter table P_{dist}. For example, for the exponential distribution, the rate parameter λᵢⱼ is estimated; for the Weiber distribution, the shape parameter kᵢⱼ and the scale parameter λᵢⱼ are estimated. This achieves the transformation from discrete-time data to a continuous distribution model.

S336. For state transition processes with insufficient sample size (such as rare risk modes or unique states of novel high dams), a parameter transition learning method is designed. This method borrows parameter information from similar state transitions, uses Bayesian inference to estimate the prior distribution, and updates the posterior distribution using limited sample data, forming a sparse state transition parameter estimation set P_sparse. This solves the problem of modeling the temporal distribution of sparse states.

S337. Based on physical failure mechanisms and reliability theory, design physical constraint correction functions to verify and correct the physical rationality of statistically estimated distribution parameters, ensuring that the time distribution conforms to physical laws, and obtain the physical correction parameter set P_{phy}. For example, for the crack propagation process caused by material fatigue, correct the distribution parameters to conform to Paris's law; for the seepage erosion process, correct the parameters to conform to the seepage evolution law.

S338. For each state transition process Si→Sj, based on its distribution type and parameters, calculate key time characteristics, including the mean μᵢⱼ (expected transition time), varianceσᵢⱼ² (time volatility), median mᵢⱼ (typical transition time), and quantile qᵢⱼ, α (reliability interval), forming a time characteristic matrix T_{feat}. This matrix comprehensively describes the time characteristics of each state transition process, providing a quantitative basis for risk assessment and intervention decisions.

S339. Integrate the time distribution functions and parameters of all state transition processes to construct a complete state duration distribution matrix D. Each element Dᵢⱼ of this matrix contains the time distribution function Tᵢⱼ (t) of the state transition Si→Sj and its parameters. This transforms the static failure path network into a dynamic model with a time dimension, achieving for the first time a temporal representation of the high dam failure process, and providing a mathematical foundation for subsequent temporal evolution analysis and risk warning.

According to one aspect of the present disclosure, step S35 specifically comprises:

S351. Read the external factor data matrix F, the state transition probability matrix P, and the state duration distribution matrix D to determine the key state transition processes that require the establishment of conditional relationships, forming a key transition process set Kₜᵣₐₙₛ. This set contains state transition processes that have a significant impact on the safety of high dams, such as crack initialization→crack propagation, and seepage anomaly→piping formation.

S352. Conduct importance analysis on the factors in the external factor data matrix F. Use statistics such as mutual information (MI) and correlation ratio (CR) to assess the influence of each factor on the state transition probability and time distribution. Select the k factors with significant influence and construct a key external factor set F_{key}={F1, F2, . . . , Fk}. Key factors typically include water level changes, temperature cycles, seismic activity, and load history.

S353. Design a data stratification (hierarchical) strategy. According to the value range of each factor in the key external factor set F_{key}, divide the factor space into multiple intervals to form a multi-dimensional grid and construct a factor hierarchical framework G. This framework discretizes the complex multi-factor space into a finite number of factor combination regions, facilitating the establishment of conditional relationships.

S354. For each key state transition process Si→Sj and each factor combination region g in the factor hierarchical framework G, state transition cases under corresponding conditions are selected from the high dam risk incident case dataset. The frequency of state transitions is counted, the conditional transition probability P(Sj|Si,g) is calculated, and a discrete conditional probability table CP discrete is constructed. This achieves a preliminary correlation between state transition probability and external factors.

S355. For regions with insufficient discrete sampling points, a conditional probability interpolation function is designed. Based on physical laws and mathematical models, continuous probability estimation is achieved in the factor space, constructing a continuous conditional probability model (CP_{continuous}). The interpolation method employs non-parametric models such as radial basis function (RBF) networks or Gaussian process regression (GPR), which can effectively handle high-dimensional sparse data. This solves the problem of incomplete data coverage.

S356. Analyze the interactions between external factors, design interaction term modeling strategies, capture the nonlinear effects under the combined action of multiple factors, and form an interaction effect model (I_{model}). For example, the synergistic effect of water level changes and temperature fluctuations may have a greater impact than their individual effects; this interaction effect can be modeled using cross-terms or kernel methods.

S357. Integrating the discrete conditional probability table (CP_{discrete}), the continuous conditional probability model (CP_{continuous}), and the interaction effect model (I_{model}), a complete conditional state transition probability function Pᵢⱼ(F1,F2, . . . ,Fk) is constructed. This function adopts a piecewise continuous mathematical form and can calculate the corresponding state transition probability for any given combination of external factors. This achieves dynamic modulation of the transition probability by external factors.

S358. Similarly, based on the time parameters (such as mean μᵢⱼ and varianceσᵢⱼ²) in the state duration distribution matrix D and the factor hierarchical framework G, the relationship between the time distribution parameters and external factors is analyzed, and parameter mapping functionsμᵢⱼ=g(F1,F2, . . . ,Fk) andσᵢⱼ²=h(F1,F2, . . . ,Fk) are established. The mapping functions are implemented using techniques such as multiple regression, response surface methodology, or neural networks, and can predict the state transition time characteristics under different external conditions.

S359. The performance of the conditional transition probability and time parameter mapping model is verified. Cross-validation is used to evaluate the model's prediction accuracy. Sensitivity analysis is conducted to determine the model's response characteristics to changes in external factors, forming the final non-stationary Markov model parameter set Θ. This parameter set fully describes the variation of state transition characteristics with external factors, providing a mathematical tool for simulating the failure process of high dams under complex conditions, and is the core of achieving non-stationary failure evolution prediction.

According to one aspect of the present disclosure, step S36 specifically comprises:

S361. Extract the main risk mode types from the high dam risk incident case dataset and the risk mode classification system Y, including cracking mode (CM), deformation mode (DM), seepage mode (FM), etc., to form a risk mode type set MODE={CM, DM, FM, . . . }. Each risk mode represents a typical physical manifestation of high dam failure.

S362. For each risk mode m in the risk mode type set MODE, extract the state nodes and transition relationships related to that mode from the initial failure path network Z, construct a mode-specific subnetwork Zm, forming a mode subnetwork set Z_{sub}={ZCM, ZDM, ZFM, . . . }. Each subnetwork focuses on describing the evolution process of a specific risk mode.

S363. For each mode subnetwork Zm, based on the theory of high dam engineering mechanics and historical case analysis, supplement the state nodes and transition relationships that may exist but are not fully reflected in the data, optimize the network topology, and form an enhanced mode subnetwork Z′m. This makes up for the deficiencies in historical data and allows the subnetwork to more completely describe the failure evolution process.

S364. Define network parameters for each model-enhanced subnetwork Z′m, including node attributes (such as state duration and severity) and edge attributes (such as transition probability and transition time), and construct the model network parameter set Pm. These parameters transform the model subnetwork from a qualitative description to a quantitative model, enabling numerical simulation and quantitative analysis.

S365. Construct a multi-layer network structure by treating all mode enhancement subnetworks Z′m as independent layers, forming the initial multi-layer risk mode network MO. This network separates different types of risk modes into relatively independent layers, facilitating the analysis of the internal evolution of each mode, and providing a basic framework for subsequent inter-mode coupling analysis.

S366. Based on high dam engineering practice and mechanical principles, analyze the physical interaction mechanisms between different risk modes, identify key inter-mode influence paths, and construct a set of mode coupling paths L. For example, crack development may affect the seepage path(CM→FM), and seepage anomalies may accelerate material degradation leading to new cracks (FM→CM). These coupling relationships reflect the mutual promotion or inhibition effects between risk modes.

S367. For each coupling path l (i,j) (from mode i to mode j) in the mode coupling path set L, design a coupling strength evaluation method, comprehensively considering physical mechanism analysis, historical case statistics, and expert knowledge, calculate the influence strength Cᵢⱼ, and construct the risk mode coupling strength matrix C. The coupling strength adopts a standardized value in the interval [−1,1], where positive values represent promoting effects, negative values represent inhibiting effects, and the absolute value represents the degree of influence.

S368. Design a coupled dynamics equation to describe the dynamic adjustment mechanism of state transition probabilities under mode coupling: P′ᵢⱼ=Pᵢⱼ+Σ(Ckm·f(Sk,Sm)), where f(Sk,Sm) is the interaction function between states. This equation can calculate the corrected transition probability considering mode coupling and construct a coupled adjustment probability model CP. This achieves a quantitative description of state evolution by the interaction between risk modes.

S369. The risk mode coupling strength matrix C and the coupling adjustment probability model CP are integrated into the multilayer risk mode network MO to establish interlayer connections and dynamic adjustment mechanisms, forming a complete multilayer risk mode network M. This network is a multilayer, weighted, dynamic, and complex network structure that not only describes the internal evolution of each risk mode but also characterizes the interaction relationships between modes. It breaks through the limitations of traditional single failure path analysis, capturing the synergistic effects and competitive relationships between risk modes, and providing a new perspective for understanding and predicting complex failure processes.

According to one aspect of the present disclosure, step S37 specifically comprises:

S371. Read the multi-layer risk mode network M, the risk mode coupling strength matrix C, and the initial failure path network Z. Analyze the network structure characteristics, including node connectivity, path length distribution, and key node distribution, and construct a network feature statistics set E. This statistics set describes the topological characteristics of the failure path network and provides a reference for subsequent path generation.

S372. Design a path generation rule base, including physical rationality rules (constraints based on mechanical principles), historical similarity rules (references based on case modes), and structural integrity rules (based on network topology requirements), forming a path generation rule set R. The rule set is described using a formal language, such as “If state A occurs and environmental conditions X are met, then it may transition to state B.” Each rule has corresponding triggering conditions and execution actions.

S373. Based on the path generation rule set R, design a rule execution engine. Employing a forward inference mechanism, starting from the initial state, it iteratively generates possible state transition sequences according to the rule set, constructing a rule-driven path set P_rule. This engine can automatically explore the rule-allowed state space and discover failed paths that may exist but have not appeared in historical data.

S374. Combining the risk mode coupling mechanism, a cross-layer path generation algorithm is designed. This algorithm can jump between mode layers and, based on the risk mode coupling strength matrix C, generate composite paths containing interactions of multiple risk modes, forming a cross-mode path set P_cross. For example, it can jump from a certain state in the fracture layer to a related state in the seepage layer through coupling relationships, and then jump back to the fracture layer, forming a composite failure path of “fracture-seepage-fracture”. It can discover cooperative failure paths that are difficult to identify in single-mode analysis.

S375. Considering the unique structural characteristics of modern ultra-high dams, a specialized path generation module is designed. Combining finite element analysis and expert knowledge, it generates dedicated failure paths tailored to the structural features of ultra-high dams, constructing a dedicated path set P_high for ultra-high dams. This module takes into account special factors such as temperature control, segmented casting, and stress distribution of ultra-high dams, enabling it to generate failure paths that better reflect the actual conditions of ultra-high dam engineering.

S376. Perform physical feasibility verification on the newly generated path sets (rule-driven path set P_rule, cross-mode path set P_cross, and ultra-high dam dedicated path set P_high). Use a combination of mechanical models and expert review to evaluate the physical feasibility of each path, filter out unreasonable paths, and retain reasonable paths to form the verification path set P_valid. Ensure that automatically generated paths conform to physical laws and avoid generating invalid paths that violate mechanical principles.

S377. Design a path scoring function that comprehensively considers physical rationality, historical similarity, and risk impact. Calculate an importance score for each path in the validation path set P_valid, and construct a path importance ranking table S path. The scoring function uses a multi-index weighted summation method to identify the critical failure paths that pose the greatest threat to high dam safety.

S378. Based on the path importance ranking table S_path, paths with scores exceeding a threshold t are selected as core expansion paths and merged with the initial failed path network Z. Redundant and low-importance paths are removed, optimizing the network structure to form a simplified expansion path network Z_opt. This network retains the most valuable expansion paths, avoiding excessive network complexity that could affect computational efficiency.

S379. Parameter estimation is performed on the simplified extended path network Z_opt. Based on historical data, physical models, and expert knowledge, reasonable transition probabilities and time distribution parameters are assigned to newly added paths, completing network quantification and ultimately forming a complete extended failure path network Z′. This network not only includes failure paths observed in historical cases but also integrates potential paths automatically generated based on rules, greatly expanding the coverage of failure path analysis and enabling it to cope with complex and ever-changing failure scenarios, especially rare path abrupt changes. It overcomes the limitations of preset paths and provides more comprehensive path coverage for high dam safety assessment.

According to one aspect of the present disclosure, step S38 specifically comprises:

S381. Read the state transition probability matrix P, state duration distribution matrix D, external factor data matrix F, multi-level risk mode network M, and extended failure path network Z′. Design a data integration framework to convert data from different sources and in different formats into a unified model input format and construct a comprehensive model input dataset I.

S382. Design a macro-scale state sequence simulation module. Based on the state transition probability matrix P and the state duration distribution matrix D, use the Monte Carlo method to simulate the state transition sequence and time process of high dam failure, realizing the overall evolution simulation from the normal state to the final failure state, and generating a macro-evolution model M_macro. This model simulates the overall trend of the failure process through random sampling and can predict the approximate path and time frame of failure.

S383. Develop a mesoscale network propagation model. Based on multilevel risk mode networks (M-mode networks) and penetration theory, simulate the propagation and spread of failures in the network, considering the interactions and cascading effects between nodes, and construct a mesoscale propagation model M meso. This model treats the failure process as the propagation of information or energy in the network, and can capture the spatial distribution characteristics and propagation dynamics of failures.

S384. Construct a microscale physical evolution model. Combining the principles of materials mechanics, fracture mechanics, and fluid mechanics, and based on the environmental conditions in the external factor data matrix F, simulate the physical field evolution process of a local region of a high dam, including stress distribution, crack propagation, and seepage changes, forming a microscopic physical model M_micro. This model describes the spatiotemporal evolution of the physical field through a system of partial differential equations, providing a detailed explanation of the physical mechanism of the failure process.

S385. Design a multi-scale model coupling framework, constructing an information transmission and feedback mechanism between macroscopic, mesoscopic, and microscopic scale models to achieve bidirectional coupling between different scales, forming a multi-scale coupling architecture C. For example, crack propagation results from the microscopic physical model can be transmitted to the mesoscopic network model as node state updates; failure propagation in the mesoscopic network can be transmitted to the macroscopic state model as a basis for transition probability adjustment. This overcomes the limitations of single-scale models, enabling the simultaneous provision of overall trends and local details.

S386. Based on the extended failure path network Z′, a path priority dynamic adjustment algorithm is designed. This algorithm evaluates the activation probability of each failure path in real time according to the system state and environmental conditions during simulation, dynamically adjusts the path weights, and constructs a path priority model P_prior. This algorithm can adaptively adjust the importance of failure paths according to changes in external conditions and system state evolution, achieving dynamic optimization of failure paths.

S387. Integrate the macroscopic evolution model M_macro, the mesoscopic spread model M_meso, the microscopic physical model M_micro, the multi-scale coupling architecture C, and the path priority model P_prior to construct a complete multi-scale temporal evolution framework, forming the comprehensive temporal evolution model M_evol. This model can simulate the temporal evolution, spatial distribution, and physical mechanisms of high dam failure processes based on given initial states and external conditions, providing a comprehensive dynamic perspective for safety assessment.

S388. Design a model solver engine, employ a hybrid numerical algorithm, including Monte Carlo sampling, Markov chain solving, network dynamics calculation, and finite element analysis, to efficiently compute the comprehensive temporal evolution model M_evol and generate a simulation results dataset R_sim. This engine selects appropriate solution strategies for models at different scales, optimizing computational efficiency and result accuracy.

S389. Develop the results analysis and visualization module, process the simulation result set R_sim, extract key time-series features, identify critical states and early warning indicators, generate a multi-dimensional visualization of the failure process, and form a time-series evolution analysis report A_evol. This report includes failure time prediction, path probability distribution, key node identification, and risk level assessment, providing intuitive and comprehensive information for decision support. It achieves full-scale, dynamic, and quantitative simulation of the high dam failure process, providing strong technical support for high dam safety assessment.

According to one aspect of the present disclosure, step S42 specifically comprises:

S421. Collect real-time monitoring data of the high dam to be evaluated, including deformation monitoring, seepage monitoring, stress monitoring, and environmental parameter monitoring data. Perform data cleaning, outlier processing, and standardization to construct a high dam monitoring dataset M_data. This dataset reflects the current working status and environmental conditions of the high dam and serves as the basic input for failure path prediction.

S422. Based on the high dam monitoring dataset M_data, combined with the high dam design parameters and operational history, assess the current state of the high dam, identify potential anomalies and early signs of damage, locate specific state nodes in the state space S, and form initial state information Sᵢₙᵢₜ. This information includes the current state assessment results of the high dam, as well as the probability distribution of various possible states, reflecting the uncertainty of the initial state.

S423. Predict the trends of external environmental changes in the high dam to be evaluated over a future period, including water level changes, temperature fluctuations, rainfall, and possible extreme events (such as floods and earthquakes), and construct a future environmental condition prediction set, E_{future}. This prediction set considers multiple possible environmental scenarios and provides external condition inputs for subsequent path simulations.

S424. Read the temporal/time-series failure path prediction model (i.e., the integrated temporal evolution model M_evol generated in step S38), take the initial state information Sᵢₙᵢₜ and the future environmental condition prediction set E_{future} as input, perform multi-scenario failure path simulation, generate a large number of possible failure evolution trajectory samples, and construct a failure trajectory sample set T_sample. This sample set contains thousands of simulated trajectories, covering the possible failure development paths of the high dam under different initial states and environmental conditions.

S425. Perform cluster analysis on the failure trajectory sample set T_sample to identify typical failure evolution modes, extract representative trajectories and key features for each risk mode, and construct a typical risk mode set T_typical. This set compresses a large number of trajectory samples into a small number of representative modes, facilitating subsequent analysis and decision-making.

S426. For each typical risk mode, calculate the key time characteristics of the failure process, including the expected duration of each state, the time window for state transitions, the time points of key nodes, and the overall failure time distribution, forming a time characteristic analysis table T_{feat}. This table provides a quantitative description of the failure process in the time dimension and is the core basis for failure risk timing assessment.

S427. Based on the typical risk mode set T_typical and the time characteristic analysis table T_{feat}, assess the probability of occurrence and risk level of each risk mode. Combined with the severity assessment of the failure consequences, construct a risk assessment matrix R. This matrix combines the failure probability and the severity of the consequences to provide a comprehensive risk level assessment result.

S428. Design a time-series risk visualization scheme that integrates failure path, time window, and risk level information into the same view. Use multi-dimensional visualization techniques (such as timeline charts, heatmaps, Sankey diagrams, etc.) to express the time-series characteristics and risk distribution of the failure process and generate a preliminary failure risk time sequence diagram G_risk.

S429. The failure risk time series diagram G_risk is optimized and enhanced by adding interactive functions, multi-level detailed information, and early warning threshold markers to improve readability and usability, resulting in the final failure risk time series diagram. This diagram intuitively displays the possible failure evolution paths of the high dam to be evaluated, the time windows of each stage, key turning points, and risk level distribution, providing a time-series-based decision-making basis for safety monitoring and risk management. It breaks through the limitations of traditional static risk assessment, revealing the dynamic characteristics of the failure process from a time dimension, and providing precise time window guidance for risk early warning and intervention decisions.

According to one aspect of the present disclosure, step S44 specifically comprises:

S441. Read the potential risk modes, failure risk time series diagrams, and verification analysis results. Design a multi-source information fusion framework to transform and normalize the assessment results from different sources according to a unified standard, constructing a comprehensive assessment input set I_comp. This input set integrates the results of similar project analogy analysis and time series evolution prediction, providing a rich information foundation for comprehensive assessment.

S442. Based on the comprehensive evaluation input set I_comp, a safety evaluation index system is constructed using the Analytic Hierarchy Process (AHP), and index weights are set to form the evaluation index system H. This index system includes three major categories of indicators: structural safety, operational reliability, and risk controllability. Each category of indicators has multiple secondary and tertiary indicators, forming a complete evaluation framework.

S443. For each indicator in the evaluation indicator system H, a quantitative score is calculated based on the relevant information in the comprehensive evaluation input set I_comp. The fuzzy comprehensive evaluation method is used to handle the uncertainty of the score, resulting in a fuzzy score vector for each indicator, and an indicator score matrix S is constructed. This matrix reflects the performance of the high dam on each evaluation indicator and serves as the basic data for the comprehensive evaluation.

S444. Combining the weights of the evaluation index system H and the index scoring matrix S, calculate the comprehensive score and the scores of each subsystem for the high dam's safety status. Based on the scoring results, determine the overall safety level and the individual safety levels, forming the safety level assessment result L. Safety levels are typically divided into four levels: normal, alert, warning, and dangerous, reflecting the current overall safety status of the high dam.

S445. Based on the failure risk time series diagram and verification analysis results, identify the most likely risk modes and weak points of high dams, analyze their physical causes and development trends, and construct a key risk point analysis table K. This table details the location, nature, severity, and development rate of each potential risk point, providing clear targets for targeted intervention.

S446. For each risk point identified in the critical risk point analysis table K, design a monitoring enhancement plan, including monitoring point layout, monitoring frequency adjustment, addition of monitoring items, and setting of early warning thresholds, forming a targeted monitoring plan M. This strengthens the monitoring coverage of critical risk points and improves the ability to detect anomalies at an early stage.

S447. Based on the safety level assessment result L and the key risk point analysis table K, and considering the actual engineering conditions and technical and economic feasibility, design a graded and phased intervention strategy, including immediate intervention measures, medium-term reinforcement plans, and long-term maintenance plans, and construct an intervention strategy matrix I. This matrix provides differentiated intervention plans for different risk levels and problem types, taking into account both rapid response to emergency risks and systematic solutions for long-term safety.

S448. Design a dynamic risk monitoring framework. Based on a time-series failure path prediction model and a targeted monitoring scheme M, establish a real-time data-driven risk assessment update mechanism, determine the periodic assessment cycle and triggering assessment conditions, and form a dynamic risk monitoring plan D. This plan establishes a closed-loop feedback between monitoring data and risk assessment, realizing continuous tracking and timely updates of the high dam's safety status.

S449. Integrate the safety level assessment results (L), key risk point analysis table (K), targeted monitoring plan (M), intervention strategy matrix (I), and dynamic risk monitoring plan (D) to compile a structured high dam safety status assessment report.

Taking a certain arch dam as the research object, this study conducts hazard mode and failure path diagnosis. This arch dam is a 300 m-class ultra-high arch dam with a relatively short operating time and insufficient monitoring information accumulation, requiring safety assessment using engineering analogy and failure path analysis. Existing technologies such as equal-weighted multivariate correspondence analysis and static failure path analysis cannot meet its assessment needs.

### Step S1: Construction of a Database of High Dam Risk Incident Cases

Step S11: Collect basic information and incident records of 235 high dam risk incident cases from engineering literature, incident reports, and monitoring records, including dam type, dam height, reservoir capacity, construction year, country of origin, incident time, incident type, incident location, and handling measures, to form original case information. The collected cases include 73 arch dams, 89 gravity dams, and 73 earth-rock dams, with construction dates ranging from 1920 to 2015.

Step S12: Clean (data clean) the original case information, handling missing and outlier values. For partially missing parameters, such as material parameters, supplement them using the average value of similar high dams; outliers are identified and handled using the 36 principle. Standardize parameter units, such as unifying dam height to meters and reservoir capacity to 100 million cubic meters. The processed data forms standardized case data containing 235 complete records.

Step S13: Based on standardized case data, extract 27 feature parameters for each case: structural features, including dam type coefficient (1.0-1.5), dam height (30 m-300 m), dam crest length, dam base width, dam thickness coefficient (0.1-0.5), and reservoir capacity (0.15 billion m³); material features, including concrete strength grade, elastic modulus, Poisson's ratio, and permeability coefficient; environmental features, including geological conditions (divided into 5 levels), climate features (divided into 4 categories), and seismic zones (divided into 4 zones); and service features, including service life, historical water level fluctuations, and historical temperature changes. All extracted feature parameters form a feature parameter matrix X, with a matrix dimension of 235×27, where each row represents a high dam case and each column represents a feature parameter.

Step S14: Analyze the incident situations in the standardized case data and identify three major risk modes: Crack mode (112 cases): including 5 subtypes such as dam heel crack, dam face crack, and dam crest crack; Abnormal deformation mode (78 cases): including 4 subtypes such as uneven settlement, excessive deformation, and top displacement; Seepage mode (45 cases): including 6 subtypes such as dam body leakage, dam foundation leakage, and joint leakage; Construct an risk mode classification system Y, adopting a two-level classification structure, with the first level being the main risk mode and the second level being the specific incident type.

### Step S15: Construction of Failure Path Network

Step S151: Extract the sequence of incident events for each case from the standardized case data, including the incident phenomenon, occurrence time, development status, and scope of impact, to form incident event time series data E. For example, the Kolnbrein arch dam record shows the cracks that appeared at the dam heel during the first impoundment in 1977, as well as the complete process of subsequent crack expansion and increased leakage.

Step S152: Perform time-series decomposition on the incident data E to identify the initial event, intermediate development events, and final result event in each case. Taking the Kolnbrein arch dam as an example, the event chain is identified as follows: initial impoundment→stress concentration at the dam heel→cracking at the dam heel→crack propagation→increased leakage→reduced structural safety factor. Perform similar analysis on all cases to construct a case-level event chain set L.

Step S153: Perform semantic normalization on all events in the event chain set L, merging events with different descriptions but the same essence into a unified whole. For example, unify “dam heel crack”, “bottom crack”, and “dam heel tension crack” into the event “dam heel crack”. After normalization, a standardized event type set T is obtained, containing 45 standard event types.

Step S154: Based on the event type set T, analyze the dependencies between events in the event chain set L, count the transition frequency between each event pair, and form an event transition frequency matrix F. For example, the transition frequency from “dam heel cracking” to “crack propagation” is 56 times, and the transition frequency from “crack propagation” to “intensified leakage” is 42 times.

Step S155: Normalize the event transition frequency matrix F and calculate the conditional probability P(j|i)=fᵢⱼ/>fik; where: P(j|i) is the conditional probability of event j occurring after event i occurs; fᵢⱼ is the historical occurrence count from event i to event j; Σfik represents the total occurrence count from event i to all possible events k; i, j, and k are event indices. For example, the conditional probability P(“crack extension” | “dam heel crack”) from “dam heel cracking” to “crack propagation” is 56/75=0.747. Calculate the conditional probabilities of all event pairs and construct the event transition probability matrix Pₑᵥₑₙₜ.

Steps S156-S159: Based on the event transition probability matrix Pₑᵥₑₙₜ, the minimum support tree algorithm is used to extract the main event transition paths, removing transition relationships with probabilities below the threshold 0=0.15, resulting in the core event transition network N_{core}. Combining high dam engineering mechanics theory and expert knowledge, the physical rationality of the network is verified, adding physically necessary but missing transition edges to form a physically corrected event network N_{phy}. Events are classified in two dimensions according to their failure type and development stage, constructing an event classification matrix C. Based on this matrix and the corrected network, the final initial failure path network Z is constructed. This network is a directed weighted graph structure, where nodes represent event types, edges represent event transition relationships, and edge weights represent transition probabilities.

Step S16: Integrate the feature parameter matrix X, the risk mode classification system Y, and the initial failure path network Z into a structured database to form a complete high dam risk incident case dataset. The dataset adopts a relational database structure, including a case basic information table, a feature parameter table, an risk mode table, and a failure path table, and establishes associations through case IDs.

### Implementation of Step S2: Multi-Scale Hierarchical Adaptive Correspondence Analysis Based on Physical Mechanisms

Step S21: Extract the feature parameter matrix X from the high dam risk incident case dataset, calculate the point-to-point bicolumn correlation coefficient Pᵢⱼ between each feature parameter and the risk mode, and construct the feature correlation matrix R. The point-to-point bicolumn correlation coefficient is calculated as follows: Pᵢⱼ=(φᵢⱼ−φi+q+j)/√(φi+(1−φi+) q+j(1−φ+j)); where: ρᵢⱼ is the point-to-point bicolumn correlation coefficient between feature j and risk mode i; φᵢⱼ is the proportion of cases that simultaneously satisfy feature j and risk mode i; φi+ is the marginal proportion of risk mode i; φ+j is the marginal proportion of feature j; i is the risk mode index; and j is the feature parameter index. For example, calculating the correlation coefficient between the dam type coefficient and the risk mode of dam heel cracks yieldsρ11=0.78, indicating a strong positive correlation between the two.

### Step S22: Feature Weight Calculation

Steps S221-S222: Read the feature correlation matrix R, extract the correlation coefficient between each feature parameter j and all risk modes, forming a feature-incident correlation coefficient set ρ_set. Calculate the average correlation coefficient ρ_avgⱼ=(1/M) ρρᵢⱼ; where: ρ_avgⱼ is the average correlation coefficient of feature j; ρᵢⱼ is the point-to-point bicolumn correlation coefficient between feature j and risk mode i; M is the total number of risk modes; >represents the summation operation from i=1 to M. For the dam type coefficient (j=1), the average correlation coefficientp_avg_1=0.76 is calculated; for the dam height ratio (j=2), the average correlation coefficientp_avg_2=0.82 is calculated; for the elastic modulus ratio (j-3), the average correlation coefficientp_avg_3=0.65 is calculated. Summarize the average correlation coefficients of all features to form the average correlation coefficient vector ρ_avg.

Steps S223-S224: Perform a significance test on the values in the average correlation coefficient vector ρ_avg, calculate the p-value, and remove features with p>0.05, retaining 21 significantly correlated features to form a significant feature index set J_sig. For the features in the significant feature index set J_sig, introduce 10 experts to score their importance (0-1 points), calculate the average score as the expert weight coefficient eⱼ, and construct the expert weight vector E. For example, the expert weight e_1 for the dam type coefficient is 0.85, and the expert weight e_2 for the dam height ratio is 0.92.

Steps S225-S228: Design a fusion function to perform weighted fusion of the data-driven average correlation coefficient vector ρ_avg and the expert weight vector E: The fusion weight calculation formula is fⱼ=α·ρ_avgⱼ+(1−a)·eⱼ; where: fⱼ is the fusion weight value of feature j; ρ_avgⱼ is the average correlation coefficient of feature j; eⱼ is the expert weight coefficient of feature j; α is the adaptive fusion coefficient, with a value range of [0,1].

Based on the data quality assessment, α=0.7 is determined. For the dam type coefficient (j=1), the fusion weight f_1=0.7×0.76+0.3×0.85=0.787 is calculated. The fusion weights of all features are then calculated to form the fusion weight value vector F.

Sensitivity analysis and stability adjustment were performed, and the stability adjustment weight vector G was normalized to obtain the initial feature weight vector W0, in which the dam type coefficient weight w_1=0.092, the dam height ratio weight w_2=0.105, and the elastic modulus ratio weight w_3=0.078.

### Step S23: Layered and Weighted Risk Mode

Based on the risk mode classification system Y, the 235 high dam cases were divided into three categories: cracking mode (C1, 112 cases), abnormal deformation mode (C2, 78 cases), and seepage mode (C3, 45 cases), and a feature parameter sub-matrix Xᵢ specific to each mode was constructed. For each feature parameter sub-matrix Xᵢ, the correlation coefficient between the feature and the sub-mode was calculated, and a mode-specific feature correlation sub-matrix Ri was constructed. For each feature correlation sub-matrix Rᵢ, the feature weight calculation method of step S22 was applied to obtain the feature weight vector Wᵢ for the specific risk mode i

For example, the feature weight vector W_1 of the cracking mode (i=1) focuses on stress-related features, such as dam type coefficient (w_11=0.126), dam height ratio (w_12=0.135), and bending radius (w_13=0.114). The feature weight vector W_3 of the seepage mode (i=3) focuses on permeability-related features, such as material permeability coefficient (w_31=0.152), seepage prevention measures (w_32=0.138), and geological conditions (w_33=0.127).

Analyze the sample characteristics of each mode subset, calculate the sample size nᵢ, sample coverage cᵢ, and sample diversity index dᵢ, and construct the mode sample characteristic matrix D. Based on the mode sample characteristic matrix D, evaluate the reliability coefficient rᵢ of each mode weight vector and construct the mode weight reliability vector R_mode. For mode j with reliability below the threshold 2=0.6, such as the seepage mode (r_3=0.58), a transfer learning strategy is used to reinforce the weights Wⱼ′=Wⱼ+·γ·Σ(sim(j,k)·(W_k−Wⱼ)); where: Wⱼ′ is the reinforced weight vector; Wⱼ is the original weight vector; sim(j,k) is the similarity between mode j and k; γ is the transfer strength coefficient; >represents the summation over all similar modes k. For the seepage mode, γ=0.4 is used to transfer weight information from the crack and deformation modes to obtain the reinforced weight vector W_3′. Combine the feature weight vectors of all modes into an m×n dimensional matrix to form the complete mode feature weight matrix WM. Each row of the matrix represents a risk mode, and each column represents a feature parameter. The matrix element WMᵢⱼ represents the weight value of feature j under risk mode i. The coefficient of variation (CV) of each feature weight is calculated between different modes to identify mode-sensitive features (large CV value) and mode-stable features (small CV value), and a feature mode sensitivity vector S_{feature} is constructed.

### Step S24: Construction of the Correlation Matrix of Risk Modes

The relationships between different risk modes are analyzed, the conversion probabilities and co-occurrence frequencies between modes are calculated, and an risk mode correlation matrix R is constructed. For example, the correlation coefficient r13 between the crack mode and the seepage mode is 0.65, indicating that the two modes have a strong correlation.

### Step S25: Construction of Physical Similarity Index System

To analyze the physical mechanism of high dam failure, four key physical quantities were selected: stress field (σ), deformation field (ε), seepage field (Φ), and damage evolution (D), constructing a set K of key physical quantities. For each physical quantity, a similarity measurement function was designed, forming a set Φ of physical similarity measurement functions. Examples include the stress distribution similarity function φ_{σ} and the deformation mode similarity function φ_{ε}.

Identify key feature parameter combinations that affect the distribution of various physical quantities, and establish a mapping set {M_{σ}, M_{ε}, M_{f}, M_d} between feature parameters and physical quantities. For example:
Stress mapping M_{σ}: mainly considers parameters such as dam type, dam height, thickness-to-height ratio, and bending radius;
Seepage mapping M_{f}′: mainly considers parameters such as permeability coefficient, seepage prevention facilities, and geological conditions;
For stress distribution similarity (o similarity), a calculation function is designed: P_{σ} (i,j)=exp(−∥Γσ(X_{σi})−Γσ(X_{σj})∥²/2θσ²); where: P_{σ} (i,j) is the stress distribution similarity between dam i and j; X_{σi} is the stress-related feature subset of dam i; Γσ is the stress field feature mapping function; ∥·∥ represents the Euclidean distance; and θσ is the scaling parameter.

For a certain arch dam and the Kolnbrein arch dam, stress-related features are extracted: X_{σ}_1=[1.2, 294, 0.32, 456] for the certain arch dam; X_{σ}_2=[1.15, 200, 0.28, 425] for the Kolnbrein arch dam; representing [dam type coefficient, dam height (m), thickness-to-height ratio, and bending radius (m)], respectively. The stress field feature vector is obtained by applying the stress field feature mapping function To transformation, and the stress similarity P_{σ}(1,2)=0.875 is calculated. Similarly, the deformation similarity P_{ε}(1,2)=0.823, the seepage similarity P_{f}(1,2)=0.762, and the damage similarity P__{d}(1,2)=0.798 are calculated. By combining the various physical similarity indices, a physical similarity index vector P_12=[0.875, 0.823, 0.762, 0.798] is formed. A complete physical similarity index matrix P is constructed by calculating the physical similarity indices for all high dam pairs.

The correlation between the indicators in the physical similarity index matrix P is analyzed to identify redundant and complementary indicators, and the physical similarity index system is optimized. Finally, the mapping relationship F between physical indicators and basic feature parameters is determined: feature parameter matrix X→physical similarity index matrix P.

Steps S26 to S28: obtain the feature parameter matrix X and mapping relationship F, and calculate the original physical similarity index matrix P. The structural differences between a certain arch dam as a modern ultra-high arch dam and historical cases are analyzed, identifying three key difference features: ultra-high dam body shape (d_1), low-heat cement materials (d_2), and intelligent temperature-controlled construction (d_3), constructing a structural difference feature set D. The impact of each difference feature on each physical similarity index is evaluated, constructing a difference-impact mapping table M_diff. For example, the influence coefficient of the ultra-high dam body shape (d_1) on stress similarity is c_11=1.15, and the influence coefficient on deformation similarity is c_12=1.23.

Design a structural difference compensation function P′_k (i,j)=P_k (i,j)· [ ] (1+8_km d_m); where: P′_k (i,j) is the corrected physical similarity index k; P_k (i,j) is the original physical similarity index k; δ_km is the influence coefficient of the difference feature m on the physical index k; d_m is the intensity value of the difference feature m; Π represents the multiplication operation.

The stress similarity between a certain arch dam and the Kollnbrein arch dam is compensated: the original stress similarity P_{σ}(1,2)=0.875; the difference in the ultra-high dam body shape d_1=0.45; the influence coefficientò, 1=0.15; the corrected stress similarity P′σ(1,2)=0.875×(1+0.15×0.45)=0.934; similarly, the corrected values of other physical indices are calculated, resulting in the corrected physical similarity index vector P′_12=[0.934, 0.893, 0.762, 0.846]. By performing similar compensation on all high dam pairs, the corrected physical similarity index matrix P′ is obtained.

Twenty-seven feature parameters of a certain arch dam are extracted to construct the feature vector X0 of the high dam to be evaluated. The physical mapping relationship F and the compensation function H are applied to obtain the physical similarity index vector P0 of the high dam to be evaluated. In the original feature space, the weighted Euclidean distance between the arch dam and historical cases is calculated: DX(0,j)=√(Σ(wi·(X0i−Xji)²); where: DX(0,j) is the distance between the high dam to be evaluated 0 and historical case j in the original feature space; wi is the weight coefficient of feature i; X0i is the feature i value of the high dam to be evaluated; Xji is the feature i value of historical case j; >represents the summation over all features i. For example, the feature space distance DX(0,2) between the arch dam and the Kollnbrein arch dam is calculated as 0.263.

In the physical similarity space, the weighted Euclidean distance between the high dam to be evaluated and historical cases is calculated, i.e., the physical spatial distance calculation formula is DP(0,j)=√(Σ(vk·(P0k−P′jk)²); where: DP(0,j) is the distance between the high dam to be evaluated 0 and historical case j in the physical similarity space; vk is the weight coefficient of the physical similarity index k; P0k is the physical similarity index k value of the high dam to be evaluated; P′jk is the modified physical similarity index k value of historical case j; 2 represents the summation over all physical indices k. The physical spatial distance between a certain arch dam and the Kollnbrein arch dam is calculated as DP(0,2)=0.118.

### Step S29: Multi-Scale Fusion Strategy

Read the original feature space distance DX and physical similarity space distance DP, and construct a dual spatial distance vector V_{dist}=[DX, DP].

Design a distance-similarity transformation function to convert distance into similarity: SX=exp(−DX2/20X2), and SP=exp(−DP²/2σP²); where: SX is the similarity in the original feature space; SP is the similarity in the physical similarity space; DX is the distance in the original feature space; DP is the distance in the physical similarity space; and σX and σP are scaling parameters.

For a certain arch dam and the Kollnbrein arch dam, taking σX=0.5 and σP=0.3, the feature space similarity SX=exp(−0.2632/0.5)=0.78 and the physical space similarity SP=exp(−0.1182/0.3)=0.89 are calculated. To evaluate the data quality of the two spaces, the original feature space credibility QX=0.65 and the physical space credibility QP=0.82 are determined. The adaptive weighting factor α=QX/(QX+QP) is calculated, where a is the fusion weighting factor; QX is the credibility evaluation index of the original feature space; and QP is the credibility evaluation index of the physical similarity space. α=0.65/(0.65+0.82)=0.44 is obtained by calculation.

Based on the probability vector of the failure risk of a certain arch dam, p= [0.65, 0.25, 0.10] (representing the risk probabilities of cracks, deformation, and seepage, respectively) and the model space weight adjustment matrix B, the weight factor α_{adj}=0.42 after comprehensive adjustment is calculated.

Calculate the multi-scale fusion similarity S(i,j)=α_{adj}·SX(i,j)+ (1−α_{adj})SP(i,j); where: S(i,j) is the final similarity between dam i and j; SX(i,j) is the similarity in the original feature space; SP(i,j) is the similarity in the physical similarity space; and α_{adj} is the adaptive weight factor after comprehensive adjustment.

For a certain arch dam and the Kolnbrein arch dam, the final similarity S(1,2)=0.42×0.78+0.58×0.89=0.843 is calculated.

To address the need for multi-objective optimization, a multi-dimensional similarity vector Sₘᵤₗₜᵢ=[S_{struct}, Sₘₐₜ, Sₑₙᵥ] is calculated, which describes the similarity relationships in detail from three dimensions: structural similarity, material similarity, and environmental similarity.

Based on the final similarity scores, the historical cases were ranked, resulting in the top 5 most similar projects: Kolnbrein Arch Dam (0.843), Mica Arch Dam (0.812), Ertan Arch Dam (0.795), Hoover Arch Dam (0.766), and Mauvoisin Arch Dam (0.754), forming a weighted similar-project ranking list.

Implementation of step S3: Temporal adaptive network evolution of multiple risk mode coupling

Step S31: Extract the initial failure path network Z from the high dam risk incident case dataset, and define the state space S={S0, S1, S2, . . . , Sf}, where S0 represents the normal state, S1 represents the micro-cracks at the dam heel, S2 represents crack propagation, S3 represents abnormal seepage, and Sf represents the failure state. A total of 12 key state nodes are identified, forming the complete state space S.

Step S32: Based on historical cases in the high dam risk incident case dataset, count the transition frequency between each state and calculate the state transition probability matrix P. For example, P(S1|S0)=0.08 (the probability of the normal state changing into a microcrack at the dam heel), P(S2|S1)=0.32 (the probability of a microcrack at the dam heel developing into a crack propagation).

Step S33: Fitting the time distribution function

Cases with complete time records were selected from the high dam risk incident case dataset to form a time-series complete case set T_cases, containing 87 cases. For each case, its state sequence and transition process were identified, and the transition time data of each pair of adjacent states Si→Sj were extracted to construct the state transition time dataset Tdata.

Data clean is performed on the state transition time dataset Tdata to remove outliers. Box plots were used to identify outlier time records, and values exceeding the upper and lower limits were replaced with critical values, resulting in the cleaned time dataset Tclean.

For each pair of state transitions, time samples are extracted, and the data distribution characteristics are analyzed. The Shapiro-Wilk test is used to determine the distribution type, and a distribution type mapping table M_{dist} is constructed. For example, the time sample of S1→S2 (microcracks in the dam heel develop into crack propagation) conforms to a log-normal distribution; the time sample of S2→S3 (crack propagation develops into seepage anomaly) conforms to a Weiber distribution. Parameter estimation is performed on the time samples of each pair of state transitions, and the distribution parameters are fitted using the maximum likelihood estimation method to form a distribution parameter table P_{dist}. For example, the log-normal distribution parameters of S1→S2 are: u12=1.8, 6122=0.5; the Weiber distribution parameters of S2→S3 are: shape parameter k23=2.1, scale parameter 223=2.8. For state transitions with insufficient sample size (such as S3→Sf), a parameter transition learning method is used to borrow parameter information from similar state transitions, and the parameters are estimated as: p3f=2.3, 63f2=0.7. Based on the physical failure mechanism, the statistically estimated distribution parameters are physically validated and corrected to ensure that the time distribution conforms to physical laws, thus obtaining the physical correction parameter set P_{phy}.

For each state transition process, based on its distribution type and parameters, key time characteristics are calculated: mean μᵢⱼ (expected transition time); varianceoij2 (time volatility); median mᵢⱼ (typical transition time); quantiles qᵢⱼ, a (reliability interval); form a time characteristic matrix T_{feat}, comprehensively describe the time characteristics of each state transition process. The time distribution functions and parameters of all state transition processes are integrated to construct a complete state duration distribution matrix D. Each element Dᵢⱼ of this matrix contains the time distribution function Tᵢⱼ (t) of the state transition Si→Sj and its parameters.

Step S34: Construction of the external factor data matrix

The present disclosure analyzes the main external factors influencing the failure process of high dams, collecting historical data on factors such as water level changes, temperature fluctuations, and load history to construct an external factor data matrix F. This matrix contains time series data for each external factor, providing a basis for conditional state transition probability modeling.

Step S35: Establishing the conditional state transition probability function

Read the external factor data matrix F, the state transition probability matrix P, and the state duration distribution matrix D to determine the key state transition processes that require the establishment of conditional relationships, forming a key transition process set Kₜᵣₐₙₛ. Perform an importance analysis on the external factors to assess the degree of influence of each factor on the state transition, and select water level change (F1), temperature change (F2), and load history (F3) as key factors to construct a key external factor set F_{key}.

A data hierarchical strategy is designed to divide the factor space into multiple intervals, forming a multi-dimensional grid, and constructing a factor hierarchical framework G. The state transition frequency under each factor combination region is statistically analyzed, and the conditional transition probability is calculated to construct a discrete conditional probability table CP discrete. For regions with insufficient sampling points, a conditional probability interpolation function is designed, and a radial basis function network is used to achieve continuous estimation, constructing a continuous conditional probability model CP continuous. The interactions between external factors are analyzed, and an interaction term modeling strategy is designed to capture the nonlinear effects of multiple factors working together, forming an interaction effect model I_{model}.

Integrating the aforementioned models, a complete conditional state transition probability function is constructed: Pᵢⱼ(F1,F2,F3)=Pᵢⱼ·(1+1·(F1−F1_ref)/F1_max+β2·(F2-F2_ref)/F2_max+β3·(F3-F3_ref)/F3_max+β12·F1·F2/F1_max/F2 max+13·F1·F3/F1_max/F3_max+β23·F2·F3/F2_max/F3_max); where: Pᵢⱼ(F1,F2,F3) is the conditional transition probability from state i to state j under the influence of external factors F1, F2, F3; Pᵢⱼ is the baseline transition probability; β1, β2, β3 are the first-order influence coefficients; β12, β13, 23 are the interaction influence coefficients; F1_ref, F2_ref, F3_ref are reference values; F1_max, F2_max, F3_max are normalization coefficients.

For the S1→S2 transition process of a certain arch dam (the development of microcracks at the dam heel into crack propagation), the relevant parameters are: baseline probability P12=0.32; water level influence coefficient β1=0.65; temperature influence coefficient β2=0.43; load influence coefficient β3=0.28; water-temperature interaction coefficient β12=0.15; when the water level ratio (F1-F1_ref)/F1_max=0.8 and the temperature deviation (F2-F2_ref)/F2_max=0.5, the conditional transition probability is calculated as: P¹² (0.8,0.5,0)0.32×(1+0.65×0.8+0.43×0.5+0.15×0.8×0.5)=0.32×1.698=0.543.

Similarly, the mapping relationship between time distribution parameters and external factors is established, and the formula is: Time parameter mapping functionμᵢⱼ(F1,F2,F3)=Mᵢⱼ (1-11 (F1-F1_ref)/F1_max-y2. (F2-F2_ref)/F2_max-73. (F3-F3_ref)/F3_max−γ12·F1·F2/F1_max/F2_max); where: μᵢⱼ(F1,F2,F3) is the expected transition time from state i to state j under the action of external factors F1, F2, F3; μᵢⱼ is the baseline expected time; γ1,γ2,γ3 are the first-order influence coefficients; γ2 is the interaction influence coefficient; other parameters are the same as above.

For the S1→S2 transfer process, the parameters are: baseline expected time μ12=1.8 years; water level influence coefficient γ1=0.45; temperature influence coefficient γ2=0.32; water-temperature interaction coefficient γ12=0.12; when the water level ratio is 0.8 and the temperature deviation is 0.5, the calculated expected time is: μ12 (0.8,0.5)=1.8×(1-0.45×0.8-0.32×0.5-0.12×0.8×0.5)=1.8×0.588=1.06 years.

The model performance is verified, and the final non-stationary Markov model parameter set Q is formed, which fully describes the variation of state transition characteristics with external factors.

Step S36: Construction of a multi-layer risk mode network

The main risk modes are extracted from the high dam risk incident case dataset and risk mode classification system Y: crack mode (CM), deformation mode (DM) and seepage mode (FM), and a risk mode type set MODE is constructed.

For each risk mode, relevant state nodes and transition relationships are extracted from the initial failure path network Z to construct a mode subnetwork, forming a mode subnetwork set Z_{sub}.

Optimize the structure of each sub-network, supplement possible state nodes and transition relationships, and form a mode-enhanced sub-network Z′m.

Define network parameters for each subnetwork, including node attributes and edge attributes, and construct the mode network parameter set Pm.

By treating all the enhanced subnetworks as independent layers, an initial multi-layer risk mode network MO is constructed to achieve separate representation of different types of risk modes.

Analyze the physical interaction mechanisms between risk modes, identify key inter-mode influence paths, and construct a set of mode coupling paths L. For example, the influence of crack development on seepage (CM→FM), and the feedback of seepage anomalies on crack development (FM→CM).

For each coupling path, the influence strength between modes is evaluated, and the risk mode coupling strength matrix Cᵢⱼ=n· Pᵢⱼ· (1+8 ij· Sij) is constructed; where: Cᵢⱼ is the coupling strength of risk mode i to mode j; n is the global coupling coefficient; ¢ ij is the physical mechanism influence coefficient; δᵢⱼ is the historical data adjustment coefficient; and Sij is the expert score weight.

The parameters for the influence of the fracture mode on the seepage mode are as follows: physical mechanism influence coefficient qCF=0.75; historical data adjustment coefficient 8CF=0.6; expert score weight SCF=0.8; global coupling coefficient n=0.5; calculated coupling strength CCF=0.5×0.75×(1+0.6×0.8)=0.45. The calculated coupling strength CFC for the influence of the seepage mode on the fracture mode is 0.38.

Design a coupled dynamic equation to describe the corrected transition probability considering mode coupling, where the coupled dynamic equation is P′ᵢⱼ=Pᵢⱼ+2 (Ckm. f(Sk,Sm)); where: P′ij is the corrected transition probability considering mode coupling; Pᵢⱼ is the original transition probability; Ckm is the coupling strength of risk mode k to mode m; f(Sk,Sm) is the state interaction function; >represents the summation over all relevant mode pairs (k,m). For the S1→S2 transition (microcracks at the dam heel develop into crack propagation) in a crack network of an arch dam, the original transition probability P¹²⁼0.32. Considering the coupling effect of the seepage mode on the crack mode, CFC· f(SF,SC)=0.38×0.25=0.095, the corrected transition probability P′12=0.32+0.095=0.415 is calculated.

The coupling relationship is integrated into a multi-layer network to form a complete multi-layer risk mode network M, which describes the internal evolution of each risk mode and the interaction between modes.

### Step S37: Adaptive Path Generation

The multi-layer risk mode network M, the risk mode coupling strength matrix C, and the initial failure path network Z are read and analyzed to construct a network feature statistics set E. A path generation rule base is designed, containing 30 specific rules, forming a path generation rule set R. For example, the rule “If a dam heel crack appears and the water level change rate exceeds 0.5, it may develop into an arch crown crack” is used. Based on the rule set, forward reasoning is performed to iteratively generate possible state transition sequences starting from the initial state, constructing a rule-driven path set P_rule, containing 45 newly generated possible paths. A cross-layer path generation algorithm is designed to jump between mode layers, generating composite paths containing multiple risk mode interactions, forming a cross-mode path set P_cross, containing 28 cross-mode paths. For example, the path “dam heel crack→seepage anomaly→arch crown crack” describes the complex failure process where cracks induce seepage and then induce new cracks. For the characteristics of a certain ultra-high arch dam, a dedicated failure path is generated, considering special factors such as temperature control and the interaction between the arch and beam, forming a dedicated path set P_high for ultra-high dams, containing 12 dedicated paths. The newly generated path set was physically validated using a combination of finite element model and expert review to assess the physical feasibility of each path. Valid paths were retained to form a valid path set P_valid, totaling 63 valid paths.

A path scoring function is designed, comprehensively considering physical rationality, historical similarity, and risk impact. An importance score is calculated for each path in the validation path set P_valid, constructing a path importance ranking table S_path. Paths with scores exceeding the threshold t-0.65 are selected as core expansion paths and merged with the initial failed path network Z to form a simplified expanded path network Z_opt, containing a total of 75 core paths (original and newly added). Parameter estimation is performed on the simplified expanded path network Z_opt, assigning transition probabilities and time distribution parameters to the newly added paths, completing network quantification, and forming the complete expanded failed path network Z′.

Step S38: Construction of a multi-scale temporal evolution model

A comprehensive model input dataset I is constructed by integrating various data sources, serving as the unified input for the multi-scale model. A macroscale state sequence simulation module is designed, employing the Monte Carlo method to simulate the state transition sequence and time progression of high dam failure, generating the macroscale evolution model M_macro. A mesoscale network propagation model is developed, based on a multi-level risk mode network M and penetration theory, simulating the propagation and spread of failure within the network, constructing the mesoscale propagation model M_meso. A microscale physical evolution model is constructed, combining principles of materials mechanics, fracture mechanics, and fluid mechanics to simulate the physical field evolution process in local regions of the high dam, forming the microscale physical model M_micro.

A multi-scale model coupling framework is designed, constructing an information transfer and feedback mechanism between macroscopic, mesoscopic, and microscopic scale models to achieve bidirectional coupling between different scales, forming a multi-scale coupling architecture C. Based on the extended failure path network Z′, a path priority dynamic adjustment algorithm is designed to evaluate the activation probability of each failure path in real time according to the system state and environmental conditions during the simulation process, constructing a path priority model P_prior. Integrating the various sub-models and frameworks, a complete multi-scale temporal evolution framework is constructed, forming a comprehensive temporal evolution model M_evol. This model can simulate the temporal evolution, spatial distribution, and physical mechanisms of high dam failure processes based on given initial states and external conditions. A model solver engine is designed, employing a hybrid numerical algorithm to achieve efficient model computation and generate a simulation result dataset R_sim. A result analysis and visualization module is developed to extract key temporal features, identify critical states and early warning indicators, and generate a temporal evolution analysis report A_evol.

Implementation of Step S4: Engineering Analogy Analysis and Safety Assessment

Step S41: Select the five projects with the highest similarity from the weighted similarity project ranking list as the core analogy project set, with the Kolnbrein arch dam (similarity 0.843) as the most core analogy object. Analyze the historical incidents of the Kolnbrein arch dam: the dam experienced heel cracking during its first impoundment in 1977, mainly located at the contact surface of the arch dam foundation, caused by the concentration of temperature stress and water pressure stress. Based on the analogy analysis, the potential risk mode of a certain arch dam is predicted to be “the risk of cracks caused by stress concentration in the dam heel area “.

Step S42: Collect real-time monitoring data of an arch dam, including deformation monitoring, seepage monitoring, and stress monitoring, and construct a high dam monitoring dataset Mdata. Assess the current state of the high dam, identify potential anomalies, locate specific state nodes, and determine the initial state information Sᵢₙᵢₜ. Currently, the arch dam is in a normal state S0, but the stress level in the dam heel area has reached 85% of the design value, posing a potential risk of developing into S1 (microcracks in the dam heel). Predict future environmental condition trends, including water level changes and temperature fluctuations, and construct a future environmental condition prediction dataset E_{future}, which includes various scenarios such as normal operating conditions and extreme operating conditions.

The initial state information Sᵢₙᵢₜ and the future environmental condition prediction set E_{future} are input into the time-series failure path prediction model, and simulation calculations are performed to generate 1000 possible failure evolution trajectories, and a failure trajectory sample set T_sample is constructed.

Cluster analysis of the trajectory samples identified three typical risk modes: dam heel crack-dominated (65% probability); dam body deformation-dominated (25% probability); and seepage anomaly-dominated (10% probability).

Key time features were extracted for each mode in the typical risk mode set T_typical, and a time feature analysis table T_{feat} was constructed. For the most likely risk mode dominated by dam heel cracks, the key time features are as follows: from the initial state to the dam heel microcrack (S0→S1): expected time 4.2 years, 90% confidence interval [2.8 years, 6.1 years]; from microcracks to obvious cracks (S1→S2): expected time 1.6 years, 90% confidence interval [0.9 years, 2.5 years]; from obvious cracks to seepage anomalies (S2→S3): expected time 2.3 years, 90% confidence interval [1.5 years, 3.4 years].

The risk level of each risk mode is assessed, and a risk assessment matrix R is constructed, combining failure probability and consequence severity to provide a risk level assessment result. A time-series risk visualization scheme is designed, integrating failure path, time window, and risk level information to generate a preliminary failure risk time-series diagram G_risk. The time-series diagram is optimized and enhanced by adding interactive functions, multi-level detailed information, and warning threshold markers to form the final failure risk time-series diagram. This diagram intuitively displays the possible failure evolution paths of an arch dam, the time windows of each stage, and the risk level distribution, and marks three key warning points: dam heel stress exceeding the limit warning point (time T1); crack initialization warning point (time T2); and seepage anomaly warning point (time T3).

Step S43: For typical projects in the core analogy engineering collection, and considering the characteristics of a certain arch dam, a finite element numerical model is constructed to analyze the failure mechanism, verify the rationality of the potential hazard mode and failure risk time series diagram, and form the verification analysis results. The verification analysis shows that under extreme water level fluctuation conditions, stress concentration may indeed occur in the heel region of the arch dam, which is basically consistent with the hazard mechanism of the analogy project Kolnbrein arch dam, confirming the reliability of the engineering analogy results.

Step S44: Read the potential hazard modes, failure risk time series diagrams, and verification analysis results; design a multi-source information fusion framework; and construct a comprehensive assessment input set I_comp. Use the analytic hierarchy process (AHP) to construct a safety assessment index system, setting index weights to form the assessment index system H. The index system includes: structural safety (weight 0.4): stress state, deformation control, seismic resistance, etc.; operational reliability (weight 0.35): monitoring system, operation management, response speed, etc.; risk controllability (weight 0.25): early warning mechanism, emergency measures, backup plans, etc. Quantify and score each index, and use a fuzzy comprehensive evaluation method to handle the uncertainty of the scores, constructing an index scoring matrix S.

Calculate the overall score and the scores of each subsystem: Structural safety score: 85 points (safety level A); Operational reliability score: 78 points (safety level B); Risk controllability score: 82 points (safety level A); Overall safety level: A (good); The safety level assessment result L is determined to be level A (good), indicating that the overall safety status of the arch dam is currently good, but potential problems in operational reliability still need to be addressed.

Based on the failure risk time series diagram and verification analysis results, key risk points were identified, and a key risk point analysis table K was constructed. The main risk points include: stress concentration points in the dam heel area (risk coefficient 0.78); temperature control areas of the dam body (risk coefficient 0.65); and leakage areas in the grouting curtain (risk coefficient 0.52).

To address key risk points, a monitoring enhancement plan was designed, including: adding 5 stress monitoring points in the dam heel area; adjusting the existing strain monitoring frequency from once per quarter to once per month; adding an acoustic detection system in potential crack areas; and developing a targeted monitoring plan M to strengthen monitoring coverage of high-risk areas.

Design a graded and phased intervention strategy and construct an intervention strategy matrix I: Short-term strategy: Regular ultrasonic testing, once a quarter; Medium-term strategy: Optimize the water level control scheme to avoid drastic water level changes; Long-term strategy: Refer to the reinforcement experience of Kolnbrein arch dam and reserve a design scheme for the back-end support structure of the dam.

Design a dynamic risk monitoring framework, establish a data-driven risk assessment and update mechanism, determine a semi-annual periodic assessment cycle, and formulate a dynamic risk monitoring plan. Integrate all assessment results and recommendations to compile a structured high dam safety status assessment report, providing a scientific basis for the safe operation and management of a certain arch dam.

The preferred embodiments of the present disclosure have been described in detail above. However, the present disclosure is not limited to the specific details in the above embodiments. Within the scope of the technical concept of the present disclosure, various equivalent transformations can be made to the technical solutions of the present disclosure, and these equivalent transformations all fall within the protection scope of the present disclosure.

What is claimed is:

1. A method for diagnosing structural in-service performance based on high dam risk mode and failure path, comprising:
collecting information on high dam risk incident cases, constructing a high dam risk incident case database, and extracting feature parameters, risk modes, and failure paths to form a high dam risk incident case dataset;
based on the high dam risk incident case dataset, applying multi-scale hierarchical adaptive correspondence analysis to generate a weighted similar-project ranking list;
based on the high dam risk incident case dataset, constructing a time-series adaptive network model with multiple failure modes coupled to output a time-series failure path prediction model;
by combining the weighted similar-project ranking list and the time-series failure path prediction model, performing an engineering analogy analysis on a high dam to be evaluated, to generate a service safety diagnosis report,
wherein the step of generating a weighted similar-project ranking list comprises:
extracting a feature parameter matrix from the high dam risk incident case dataset, calculating to obtain a feature correlation matrix, and calculating to obtain a feature weight vector accordingly;
based on classification system of risk modes, dividing the high dam risk incident case dataset into at least two mode subsets, and calculating to obtain a feature weight of each subset to construct a mode feature weight matrix.
constructing a physical similarity index system, establishing a mapping relationship between feature parameters and physical similarity indices, calculating to obtain a physical similarity index matrix, and obtaining a modified physical similarity index matrix through structural difference compensation.
by combining outputs of the above three processes, calculating similarity between high dams, and generating the weighted similar-project ranking list.

2. The method according to claim 1, wherein the step of calculating to obtain a feature weight vector comprises:
calculating an average correlation coefficient between each feature and a risk mode to form an average correlation coefficient vector;
performing a significance test on the average correlation coefficient vector, and selecting significant correlation features to form a significant feature index set, obtaining an expert weight vector through expert scoring;
fusing the average correlation coefficient vector and the expert weight vector through weighted integration to form a fused weight value vector;
performing stability adjustment and normalization on the fused weight value vector to obtain the feature weight vector.

3. The method according to claim 1, wherein the step of constructing a mode feature weight matrix comprises:
dividing the high dam risk incident case dataset into multiple mode subsets based on the classification system of risk modes, and extracting a feature parameter sub-matrix for each mode subset;
calculating correlation coefficients between features and modes in each feature parameter sub-matrix, constructing a feature correlation sub-matrix, and calculating a mode feature weight vector;
analyzing sample distribution characteristics of each mode subset, calculating a sample size, coverage and diversity index, and constructing a mode sample characteristic matrix;
combining the feature weight vectors of all modes into a mode feature weight matrix.

4. The method according to claim 1, wherein the step of obtaining a modified physical similarity index matrix comprises:
based on a physical mechanism of high dam failure, identifying key physical quantities and constructing a similarity metric function to establish a mapping relationship between feature parameters and physical quantities;
based on the mapping relationship, calculating physical similarity index values from the feature parameter matrix, and constructing the physical similarity index matrix;
identifying structural difference features between modern ultra-high dams and historical cases, constructing a structural difference feature set, evaluating impact of each difference feature on the physical similarity index, and forming a structural difference compensation function;
based on the structural difference compensation function, compensating and correcting the physical similarity index matrix to obtain the modified physical similarity index matrix.

5. The method according to claim 1, wherein the step of generating the weighted similar-project ranking list comprises:
calculating distances of the high dam in an original feature space and a physical similarity space respectively, and constructing a dual-space distance vector;
converting the distances into similarity to obtain an original feature space similarity and a physical similarity space similarity; evaluating data quality and credibility of each space one by one, obtaining a comprehensive adjusted fusion weight factor by combining with a risk probability of the risk mode;
based on the fusion weight factor, fusing the original feature space similarity and the physical similarity space similarity through weighted integration to calculate a multi-scale fusion similarity;
based on the multi-scale fusion similarity, sorting historical cases to generate the weighted similar-project ranking list.

6. The method according to claim 1, wherein the step of outputting a time-series failure path prediction model comprises:
extracting failure path information from the high dam risk incident case dataset to construct a state space and a state transition probability matrix;
fitting a state transition process by using a time distribution function to construct a state duration distribution matrix;
analyzing impact of external factors on state transitions and constructing a conditional state transition probability function;
constructing different failure modes into a multi-layer network, extracting coupling relationship between failure modes, and generating an extended failure path network;
by combining the outputs of the aforementioned steps, constructing a multi-scale time-series evolution model, and outputting the time-series failure path prediction model through simulation calculation.

7. The method according to claim 6, wherein the step of constructing a state duration distribution matrix comprises:
selecting cases containing complete time records from the high dam risk incident case dataset, and extracting state transition time data;
cleaning the time data, analyzing its distribution characteristics, determining a theoretical distribution type, and fitting distribution parameters;
based on physical failure mechanisms, correcting distribution parameters for plausibility, and calculating expected transfer time, variance, and reliability range;
constructing the state duration distribution matrix by integrating time distribution functions and parameters of all state transition processes.

8. The method according to claim 6, wherein the step of constructing a conditional state transition probability function comprises:
identifying key state transition processes that require an establishment of conditional relationship, assessing a degree of influence of each external factor, and selecting key external factors;
designing a factor spatial hierarchical framework, statistically analyzing a frequency of state transitions under each factor combination region, and constructing a discrete conditional probability table;
designing an interpolation function for areas with insufficient sampling points, and analyzing interactions between factors to form a continuous conditional probability model. constructing the conditional state transition probability function by integrating the discrete conditional probability table and the continuous conditional probability model.

9. The method according to claim 6, wherein the step of extracting coupling relationship between failure modes comprises:
extracting main failure mode types from the high dam risk incident case dataset and constructing a failure mode type set;
for each failure mode, extracting relevant state nodes and transition relationships, and constructing and optimizing a mode subnetwork;
defining node attributes and edge attributes for each subnetwork, and constructing a multi-layer network by treating all subnetworks as an independent layer;
analyzing physical interaction mechanisms between failure modes, identifying influence paths between modes, constructing a mode coupling path set and evaluating influence strength between modes, constructing a failure mode coupling strength matrix, obtaining a coupling relationship, and forming a multi-layer failure mode network.
